(19) United States
(12) Patent Application Publication
(10) Pub. No.: US 2026/0238299 A1
(43) Pub. Date: Aug. 13, 2026

(54) BEAM MANAGEMENT IN COMMUNICATION NETWORK

(71) Applicant: TOYOTA JIDOSHA KABUSHIKI KAISHA, Toyota-shi, Aichi-ken (JP)

(72) Inventor: Shao-Yu LIEN, Tainan City (TW)

(73) Assignee: TOYOTA JIDOSHA KABUSHIKI KAISHA, Toyota-shi, Aichi-ken (JP)

(21) Appl. No.: 19/151,880

(22) PCT Filed: Jan. 22, 2024
(86) PCT No.: PCT/JP2024/001651

§ 371 Date: Jul. 29, 2025

Related U.S. Application Data
(60) Provisional application No. 63/482,084, filed on Jan. 30, 2023.

(51) Int. Cl. H04B 7/06; H04W 74/0833

(52) U.S. Cl. CPC H04B 7/06952; H04W 74/0833

(57) ABSTRACT

Disclosed are methods, apparatuses, and systems for beam management in communication. The method includes: identifying an optimum beam pair based on one or more signals received from a base station; updating one or more learning models included in the UE based on the identified optimum beam pair, the one or more learning models comprising at least one of: one or more weights, or one or more parameters; determining one or more beam directions for at least one of the UE or the base station, based on the updated one or more learning models; and transmitting, to the base station, the updated one or more learning models, or at least one of: updated one or more weights, or updated one or more parameters.

### CROSS-REFERENCE TO RELATED PATENT APPLICATION

This application claims the benefit of U.S. Provisional Application No. 63/482,084, filed on Jan. 30, 2023, entitled “BEAM MANAGEMENT IN COMMUNICATION NETWORK,” the entirety of which is incorporated by reference herein.

### TECHNICAL FIELD

Apparatuses and methods consistent with the present disclosure relate generally to communications, more specifically, methods, systems, and devices for beam management in communications.

### BACKGROUND ART

Beam management is important in communications using radio signals, especially for high frequency radio signals that suffer from high propagation loss. Beam management in downlink/uplink involves beamforming between a user equipment (UE) and a base station, which usually includes beam sweeping at the UE and the base station. In conventional methods, beam sweeping is triggered only by a base station. This causes an issue that triggering a beam sweeping by the base station may not be responsive to the need at the UE, thereby limiting the performance of beam management. Systems and methods that can allow for a UE to trigger beam sweeping are desired. Another issue in beam management is that the overheads involved in beam management are significant. The overheads may include the amount of reference signals transmitted between the UE and the base station, the number of beam sweepings performed at the UE and the base station, and the number of feedback signals provided after beam sweepings. The overheads in beam management may be reduced by utilizing artificial intelligence (AI) and machine learning (ML) (AI/ML) methods. In AI/ML methods, there can be different arrangements. For example, each of the UE and the base station may have its own learning model for determining beam directions, or the UE (or the base station) may have learning model(s) for both the UE and the base station. Coordination between the UE and the base station at different arrangements affects the overall performance of the beam management. Systems and methods that can flexibly and efficiently perform beam management at different AI/ML arrangements are desired.

### SUMMARY OF INVENTION

According to some embodiments of the present disclosure, there is provided a UE for beam management in a communication. The UE includes a memory storing an instruction; and a processor configured to execute the instruction stored in the memory to: transmit, to a base station, one or more requests for a configuration of one or more resources to be used by the UE to transmit one or more requests to trigger a beam sweeping; receive, from the base station, the configuration of the one or more resources to be used by the UE to transmit the one or more requests to trigger the beam sweeping; transmit, to the base station, the one or more requests to trigger the beam sweeping on the one or more resources configured for the UE; receive, from the base station, a confirmation for the beam sweeping; and perform the beam sweeping based on the confirmation.

According to some embodiments of the present disclosure, there is provided a UE for beam management in a communication. The UE includes a memory storing an instruction; and a processor configured to execute the instruction stored in the memory to: transmit, to a base station and through a random access procedure, one or more requests to trigger a beam sweeping, the one or more requests to trigger the beam sweeping comprising at least one of: one or more desired occasions to perform the beam sweeping, or one or more configurations for performing the beam sweeping; receive, from the base station, a confirmation for the beam sweeping; and perform the beam sweeping based on the confirmation.

According to some embodiments of the present disclosure, there is provided a base station for beam management in a communication. The base station includes a memory storing an instruction; and a processor configured to execute the instruction stored in the memory to: receive, from a UE, one or more requests for a configuration of one or more resources to be used by the UE to transmit one or more requests to trigger a beam sweeping; transmit, to the UE, the configuration of the one or more resources to be used by the UE to transmit the one or more requests to trigger the beam sweeping; receive, from the UE, the one or more requests to trigger the beam sweeping; transmit, to the UE, a confirmation for the beam sweeping; and perform the beam sweeping based on the confirmation.

According to some embodiments of the present disclosure, there is provided a base station for beam management in a communication. The base station includes a memory storing an instruction; and a processor configured to execute the instruction stored in the memory to: receive, from a UE and through a random access procedure, one or more requests to trigger a beam sweeping, the one or more requests to trigger the beam sweeping comprising at least one of: one or more desired occasions to perform the beam sweeping, or one or more configurations for performing the beam sweeping; transmit, to the UE, a confirmation for the beam sweeping; and perform the beam sweeping based on the confirmation.

According to some embodiments of the present disclosure, there is provided a base station for beam management in a communication. The base station includes a memory storing an instruction; and a processor configured to execute the instruction stored in the memory to: transmit, to a UE, one or more requests for one or more channel state information (CSI) reports, the one or more requests comprising a configuration for one or more CSI measurements to be performed by the UE; receive, from the UE, the one or more CSI reports; update one or more learning models included in the base station based on the received one or more CSI reports, the one or more learning models comprising at least one of: one or more weights, or one or more parameters; determine one or more beam directions for at least one of the base station or the UE, based on the updated one or more learning models; and transmit, to the UE, the updated one or more learning models or at least one of: updated one or more weights, or updated one or more parameters.

According to some embodiments of the present disclosure, there is provided a UE for beam management in a communication. The UE includes a memory storing an instruction; and a processor configured to execute the instruction stored in the memory to: receive, from a base station, one or more requests for one or more CSI reports, the one or more requests comprising a configuration for one or more CSI measurements to be performed by the UE; transmit, to the base station, the one or more CSI reports; receive, from the base station, an updated learning model for the UE, or at least one of: updated one or more weights, or updated one or more parameters, of the learning model for the UE, the learning model for the UE being included in the base station and updated by the base station based on the one or more CSI reports; and determine one or more beam directions for the UE based on the updated learning model for the UE, or the at least one of: the updated one or more weights, or the updated one or more parameters, of the learning model for the UE.

According to some embodiments of the present disclosure, there is provided a UE for beam management in a communication. The UE includes a memory storing an instruction; and a processor configured to execute the instruction stored in the memory to: receive, from a base station, one or more requests for one or more CSI reports, the one or more requests comprising a configuration for one or more CSI measurements to be performed by the UE; transmit, to the base station, the one or more CSI reports; receive, from the base station, one or more beam directions for the UE determined by a learning model included in the base station, the learning model being a learning model for both the UE and the base station; and determine a beam to be used by the UE based on the received one or more beam directions.

According to some embodiments of the present disclosure, there is provided a UE for beam management in a communication. The UE includes a memory storing an instruction; and a processor configured to execute the instruction stored in the memory to: identify an optimum beam pair based on one or more signals received from a base station; update one or more learning models included in the UE based on the identified optimum beam pair, the one or more learning models comprising at least one of: one or more weights, or one or more parameters; determine one or more beam directions for at least one of the UE or the base station, based on the updated one or more learning models; and transmit, to the base station, the updated one or more learning models, or at least one of: updated one or more weights, or updated one or more parameters.

According to some embodiments of the present disclosure, there is provided a base station for beam management in a communication. The base station includes a memory storing an instruction; and a processor configured to execute the instruction stored in the memory to: receive, from a UE, an updated learning model for the base station, or at least one of: updated one or more weights, or updated one or more parameters, of the learning model for the base station, the learning model for the base station being included in the UE and updated by the UE; and determine one or more beam directions for the base station based on the received updated learning model for the base station, or at least one of: the updated one or more weights, or the updated one or more parameters, of the learning model for the base station.

According to some embodiments of the present disclosure, there is provided a base station for beam management in a communication. The base station includes a memory storing an instruction; and a processor configured to execute the instruction stored in the memory to: receive, from a UE, one or more beam directions for the base station determined by a learning model included in the UE, the learning model being a learning model for both the UE and the base station; and determine a beam for the base station based on the received one or more beam directions.

According to some embodiments of the present disclosure, there is provided a method for a UE for beam management in a communication. The method includes transmitting, to a base station, one or more requests for a configuration of one or more resources to be used by the UE to transmit one or more requests to trigger a beam sweeping; receiving, from the base station, the configuration of the one or more resources to be used by the UE to transmit the one or more requests to trigger the beam sweeping; transmitting, to the base station, the one or more requests to trigger the beam sweeping on the one or more resources configured for the UE; receiving, from the base station, a confirmation for the beam sweeping; and performing the beam sweeping based on the confirmation.

According to some embodiments of the present disclosure, there is provided a method for a UE for beam management in a communication. The method includes transmitting, to a base station and through a random access procedure, one or more requests to trigger a beam sweeping, the one or more requests to trigger the beam sweeping comprising at least one of: one or more desired occasions to perform the beam sweeping, or one or more configurations for performing the beam sweeping; receiving, from the base station, a confirmation for the beam sweeping; and performing the beam sweeping based on the confirmation.

According to some embodiments of the present disclosure, there is provided a method for a base station for beam management in a communication. The method includes receiving, from a UE, one or more requests for a configuration of one or more resources to be used by the UE to transmit one or more requests to trigger a beam sweeping; transmitting, to the UE, the configuration of the one or more resources to be used by the UE to transmit the one or more requests to trigger the beam sweeping; receiving, from the UE, the one or more requests to trigger the beam sweeping; transmitting, to the UE, a confirmation for the beam sweeping; and performing the beam sweeping based on the confirmation.

According to some embodiments of the present disclosure, there is provided a method for a base station for beam management in a communication. The method includes receiving, from a UE and through a random access procedure, one or more requests to trigger a beam sweeping, the one or more requests to trigger the beam sweeping comprising at least one of: one or more desired occasions to perform the beam sweeping, or one or more configurations for performing the beam sweeping; transmitting, to the UE, a confirmation for the beam sweeping; and performing the beam sweeping based on the confirmation.

According to some embodiments of the present disclosure, there is provided a method for a base station for beam management in a communication. The method includes transmitting, to a UE, one or more requests for one or more CSI reports, the one or more requests comprising a configuration for one or more CSI measurements to be performed by the UE; receiving, from the UE, the one or more CSI reports; updating one or more learning models included in the base station based on the received one or more CSI reports, the one or more learning models comprising at least one of: one or more weights, or one or more parameters; determining one or more beam directions for at least one of the base station or the UE, based on the updated one or more learning models; and transmitting, to the UE, the updated one or more learning models or at least one of: updated one or more weights, or updated one or more parameters.

According to some embodiments of the present disclosure, there is provided a method for a UE for beam management in a communication. The method includes receiving, from a base station, one or more requests for one or more CSI reports, the one or more requests comprising a configuration for one or more CSI measurements to be performed by the UE; transmitting, to the base station, the one or more CSI reports; receiving, from the base station, an updated learning model for the UE, or at least one of: updated one or more weights, or updated one or more parameters, of the learning model for the UE, the learning model for the UE being included in the base station and updated by the UE based on the one or more CSI reports; and determining one or more beam directions for the UE based on the updated learning model for the UE, or the at least one of: the updated one or more weights, or the updated one or more parameters, of the learning model for the UE.

According to some embodiments of the present disclosure, there is provided a method for a UE for beam management in a communication. The method includes receiving, from a base station, one or more requests for one or more CSI reports, the one or more requests comprising a configuration for one or more CSI measurements to be performed by the UE; transmitting, to the base station, the one or more CSI reports; receiving, from the base station, one or more beam directions for the UE determined by a learning model included in the base station, the learning model being a learning model for both the UE and the base station; and determining a beam to be used by the UE based on the received one or more beam directions.

According to some embodiments of the present disclosure, there is provided a method for a UE for beam management in a communication. The method includes identifying an optimum beam pair based on one or more signals received from a base station; updating one or more learning models included in the UE based on the identified optimum beam pair, the one or more learning models comprising at least one of: one or more weights, or one or more parameters; determining one or more beam directions for at least one of the UE or the base station, based on the updated one or more learning models; and transmitting, to the base station, the updated one or more learning models, or at least one of: updated one or more weights, or updated one or more parameters.

According to some embodiments of the present disclosure, there is provided a method for a base station for beam management in a communication. The method includes receiving, from a UE, an updated learning model for the base station, or at least one of: updated one or more weights, or updated one or more parameters, of the learning model for the base station, the learning model for the base station being included in the UE and updated by the UE; and determining one or more beam directions for the base station based on the received updated learning model for the base station, or at least one of: the updated one or more weights, or the updated one or more parameters, of the learning model for the base station.

According to some embodiments of the present disclosure, there is provided a method for a base station for beam management in a communication. The method includes receiving, from a UE, one or more beam directions for the base station determined by a learning model included in the UE, the learning model being a learning model for both the UE and the base station; and determining a beam for the base station based on the received one or more beam directions.

According to some embodiments of the present disclosure, there is provided a non-transitory computer-readable medium storing instructions that are executable by one or more processors of a UE for communication to perform a method. The method includes transmitting, to a base station, one or more requests for a configuration of one or more resources to be used by the UE to transmit one or more requests to trigger a beam sweeping; receiving, from the base station, the configuration of the one or more resources to be used by the UE to transmit the one or more requests to trigger the beam sweeping; transmitting, to the base station, the one or more requests to trigger the beam sweeping on the one or more resources configured for the UE; receiving, from the base station, a confirmation for the beam sweeping; and performing the beam sweeping based on the confirmation.

According to some embodiments of the present disclosure, there is provided a non-transitory computer-readable medium storing instructions that are executable by one or more processors of a UE for communication to perform a method. The method includes transmitting, to a base station and through a random access procedure, one or more requests to trigger a beam sweeping, the one or more requests to trigger the beam sweeping comprising at least one of: one or more desired occasions to perform the beam sweeping, or one or more configurations for performing the beam sweeping; receiving, from the base station, a confirmation for the beam sweeping; and performing the beam sweeping based on the confirmation.

According to some embodiments of the present disclosure, there is provided a non-transitory computer-readable medium storing instructions that are executable by one or more processors of a base station for communication to perform a method. The method includes receiving, from a UE, one or more requests for a configuration of one or more resources to be used by the UE to transmit one or more requests to trigger a beam sweeping; transmitting, to the UE, the configuration of the one or more resources to be used by the UE to transmit the one or more requests to trigger the beam sweeping; receiving, from the UE, the one or more requests to trigger the beam sweeping; transmitting, to the UE, a confirmation for the beam sweeping; and performing the beam sweeping based on the confirmation.

According to some embodiments of the present disclosure, there is provided a non-transitory computer-readable medium storing instructions that are executable by one or more processors of a base station for communication to perform a method. The method includes receiving, from a user equipment (UE) and through a random access procedure, one or more requests to trigger a beam sweeping, the one or more requests to trigger the beam sweeping comprising at least one of: one or more desired occasions to perform the beam sweeping, or one or more configurations for performing the beam sweeping; transmitting, to the UE, a confirmation for the beam sweeping; and performing the beam sweeping based on the confirmation.

According to some embodiments of the present disclosure, there is provided a non-transitory computer-readable medium storing instructions that are executable by one or more processors of a base station for communication to perform a method. The method includes transmitting, to a UE, one or more requests for one or more CSI reports, the one or more requests comprising a configuration for one or more CSI measurements to be performed by the UE; receiving, from the UE, the one or more CSI reports; updating one or more learning models included in the base station based on the received one or more CSI reports, the one or more learning models comprising at least one of: one or more weights, or one or more parameters; determining one or more beam directions for at least one of the base station or the UE, based on the updated one or more learning models; and transmitting, to the UE, the updated one or more learning models or at least one of: updated one or more weights, or updated one or more parameters.

According to some embodiments of the present disclosure, there is provided a non-transitory computer-readable medium storing instructions that are executable by one or more processors of a UE for communication to perform a method. The method includes receiving, from a base station, one or more requests for one or more CSI reports, the one or more requests comprising a configuration for one or more CSI measurements to be performed by the UE; transmitting, to the base station, the one or more CSI reports; receiving, from the base station, an updated learning model for the UE, or at least one of: updated one or more weights, or updated one or more parameters, of the learning model for the UE, the learning model for the UE being included in the base station and updated by the UE based on the one or more CSI reports; and determining one or more beam directions for the UE based on the updated learning model for the UE, or the at least one of: the updated one or more weights, or the updated one or more parameters, of the learning model for the UE.

According to some embodiments of the present disclosure, there is provided a non-transitory computer-readable medium storing instructions that are executable by one or more processors of a UE for communication to perform a method. The method includes receiving, from a base station, one or more requests for one or more CSI reports, the one or more requests comprising a configuration for one or more CSI measurements to be performed by the UE; transmitting, to the base station, the one or more CSI reports; receiving, from the base station, one or more beam directions for the UE determined by a learning model included in the base station, the learning model being a learning model for both the UE and the base station; and determining a beam to be used by the UE based on the received one or more beam directions.

According to some embodiments of the present disclosure, there is provided a non-transitory computer-readable medium storing instructions that are executable by one or more processors of a UE for communication to perform a method. The method includes identifying an optimum beam pair based on one or more signals received from a base station; updating one or more learning models included in the UE based on the identified optimum beam pair, the one or more learning models comprising at least one of: one or more weights, or one or more parameters; determining one or more beam directions for at least one of the UE or the base station, based on the updated one or more learning models; and transmitting, to the base station, the updated one or more learning models, or at least one of: updated one or more weights, or updated one or more parameters.

According to some embodiments of the present disclosure, there is provided a non-transitory computer-readable medium storing instructions that are executable by one or more processors of a base station for communication to perform a method. The method includes receiving, from a UE, an updated learning model for the base station, or at least one of: updated one or more weights, or updated one or more parameters, of the learning model for the base station, the learning model for the base station being included in the UE and updated by the UE; and determining one or more beam directions for the base station based on the received updated learning model for the base station, or at least one of: the updated one or more weights, or the updated one or more parameters, of the learning model for the base station.

According to some embodiments of the present disclosure, there is provided a non-transitory computer-readable medium storing instructions that are executable by one or more processors of a base station for communication to perform a method. The method includes receiving, from a UE, one or more beam directions for the base station determined by a learning model included in the UE, the learning model being a learning model for both the UE and the base station; and determining a beam for the base station based on the received one or more beam directions.

### BRIEF DESCRIPTION OF DRAWINGS

FIG. 1A is a schematic diagram illustrating existence of a line-of-sight signal path for an optimum beam pair in downlink (DL); FIG. 1B is a schematic diagram illustrating existence of a line-of-sight signal path for an optimum beam pair in uplink (UL); FIG. 1C is a schematic diagram illustrating absence of line-of-sight signal path in downlink due to blockages between a transmitter and a receiver; and FIG. 1D is a schematic diagram illustrating absence of line-of-sight signal path in uplink due to blockages between a transmitter and a receiver, consistent with some embodiments of the present disclosure.

FIG. 2 is a schematic diagram illustrating three phases of beam management, consistent with some embodiments of the present disclosure.

FIG. 3A is a schematic diagram illustrating the procedure-1 (P1) of beam sweeping.

FIG. 3B is a schematic diagram illustrating the procedure-2 (P2) of beam sweeping.

FIG. 3C is a schematic diagram illustrating the procedure-3 (P3) of beam sweeping, consistent with some embodiments of the present disclosure.

FIG. 4 is a schematic diagram illustrating a method for beam management based on downlink SSB or CSI-RS signals, consistent with some embodiments of the present disclosure.

FIG. 5 is a schematic diagram illustrating a method for beam management based on uplink SRS signals, consistent with some embodiments of the present disclosure.

FIG. 6 is a schematic diagram illustrating scenario-1 of the AI/ML methods without labeled datasets, consistent with some embodiments of the present disclosure.

FIG. 7 is a schematic diagram illustrating a beam management method, consistent with some embodiments of the present disclosure.

FIG. 8 is a schematic diagram illustrating a method for beam management, consistent with some embodiments of the present disclosure.

FIG. 9 is a schematic diagram illustrating a beam management method, consistent with some embodiments of the present disclosure.

FIG. 10 is a schematic diagram illustrating a beam management method, consistent with some embodiments of the present disclosure.

FIG. 11 is a schematic diagram illustrating a beam management method, consistent with some embodiments of the present disclosure.

FIG. 12 is a schematic diagram illustrating a beam management method, consistent with some embodiments of the present disclosure.

FIG. 13 is a block diagram of a device 1300, consistent with some embodiments of the present disclosure.

### DESCRIPTION OF EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of systems, apparatuses, and methods consistent with aspects related to the present disclosure as recited in the appended claims.

Beamforming is a crucial technology especially for coverage extension and throughput enhancement in millimeter wave frequency radio signals. Using beamforming, a transmitter can adjust its transmitting (Tx) beam toward a certain direction, while a receiver also adjusts its receiving (Rx) beam direction toward a certain direction and reject signals coming from other directions. A beam can be wide to cover a larger area or be narrow to reach a farther area.

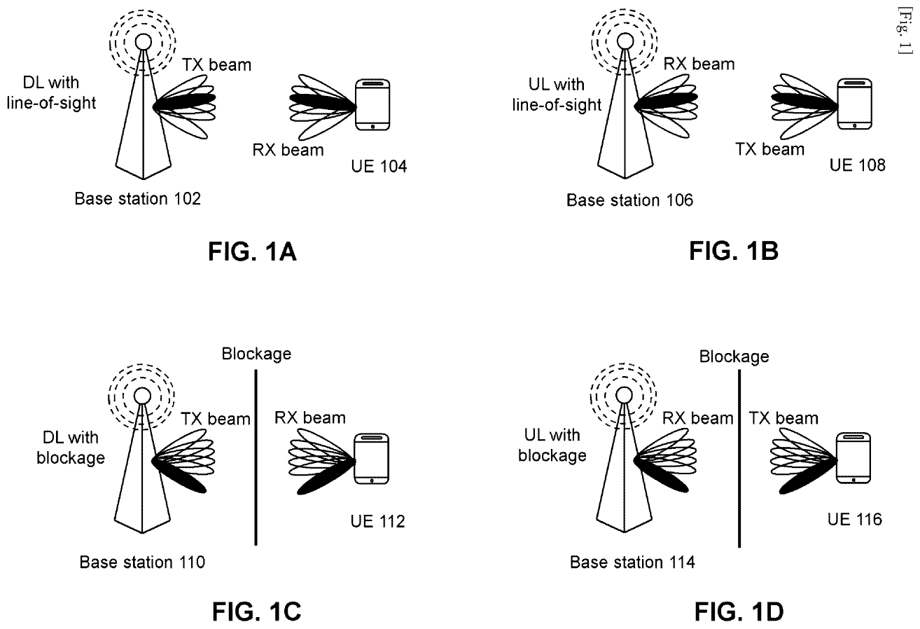

FIG. 1A is a schematic diagram illustrating existence of a line-of-sight signal path for an optimum beam pair in downlink (DL); FIG. 1B is a schematic diagram illustrating existence of a line-of-sight signal path for an optimum beam pair in uplink (UL); FIG. 1C is a schematic diagram illustrating absence of line-of-sight signal path in downlink due to blockages between a transmitter and a receiver; and FIG. 1D is a schematic diagram illustrating absence of line-of-sight signal path in uplink due to blockages between a transmitter and a receiver, consistent with some embodiments of the present disclosure. Referring to FIG. 1A, a communication system includes a base station 102 and a UE 104. The base station 102 can be any base station (e.g., gNodeB (gNB)) currently existing, such as base stations for long term evolution (LTE) or new radio (NR), or base stations for a future generation (6^{th} generation (6G), 7^{th} generation (7G), or any other future generation) radio access technology (RAT). To obtain beam alignment between the transmitter (Tx) beam of the base station 102 and the receiver (Rx) beam of UE 104, the base station 102 may transmit reference signals, such as channel station information reference signals (CSI-RS) or synchronization signal and physical broadcast channel (SSB) with different sequences at different beam directions, for example, by performing Tx beam sweeping. In the meantime, the UE 104 also arranges its Rx beam over different beam directions, for example, by performing Rx beam sweeping. The base station 102 and the UE 104 eventually find an optimum pair of Tx beam and Rx beam having a maximum received signal strength. In FIG. 1A, the black-colored portions at the Tx beam and the Rx beam indicate the optimum beam pair. In this case, there is a line-of-sight signal path for the optimum beam pair in downlink.

Referring to FIG. 1B, a communication system includes a base station 106 and a UE 108. The base station 106 may be similar to the base station 102, and the UE 108 may be similar to the UE 104 of FIG. 1A. For the sake of brevity, the descriptions of the base station 106 and the UE 108 are omitted here. Compared with FIG. 1A, in FIG. 1B, the UE 108 is a transmitter and transmits signals and/or data using Tx beam and the base station 106 is a receiver and receives the signals and/or data from the UE 108 using Rx beam. To obtain beam alignment between the Tx beam of the UE 108 and the Rx beam of the base station 106, the UE 108 may transmit reference signals, such as sounding reference signals (SRS) with different sequences at different beam directions, for example, by performing Tx beam sweeping. In the meantime, the base station 106 also arranges its Rx beam over different beam directions, for example, by performing Rx beam sweeping. The UE 108 and the base station 106 eventually find an optimum pair of Tx beam and Rx beam having a maximum received signal strength. In FIG. 1B, the black-colored portions at the Tx beam and the Rx beam indicate the optimum beam pair. In this case, there is a line-of-sight signal path for the optimum beam pair in uplink.

Referring to FIG. 1C, a communication system includes a base station 110 and a UE 112. Similar to FIG. 1A, in FIG. 1C, the base station 110 is the transmitter and the UE 112 is the receiver. To obtain beam alignment between the Tx beam of the base station 110 and the Rx beam of UE 112, the base station 110 may transmit reference signals, such as channel state information reference signal CSI-RS or SSBs with different sequences at different beam directions. However, due to a blockage between the base station 110 and the UE 112, beam alignment is not achieved, as indicated by the unaligned, black-colored portions at the Tx beam and the Rx beam, and a line-of-sight signal path does not exist in downlink.

Referring to FIG. 1D, a communication system includes a base station 114 and a UE 116. Similar to FIG. 1B, in FIG. 1D, the UE 116 is the transmitter and the base station 114 is the receiver. To obtain beam alignment between the Tx beam of the UE 116 and the Rx beam of base station 114, the UE 116 may transmit reference signals, such as SRS with different sequences at different beam directions. However, due to a blockage between the UE 116 and the base station 114, beam alignment is not achieved, as indicated by the unaligned, black-colored portions at the Tx beam and the Rx beam, and a line-of-sight signal path does not exist in uplink.

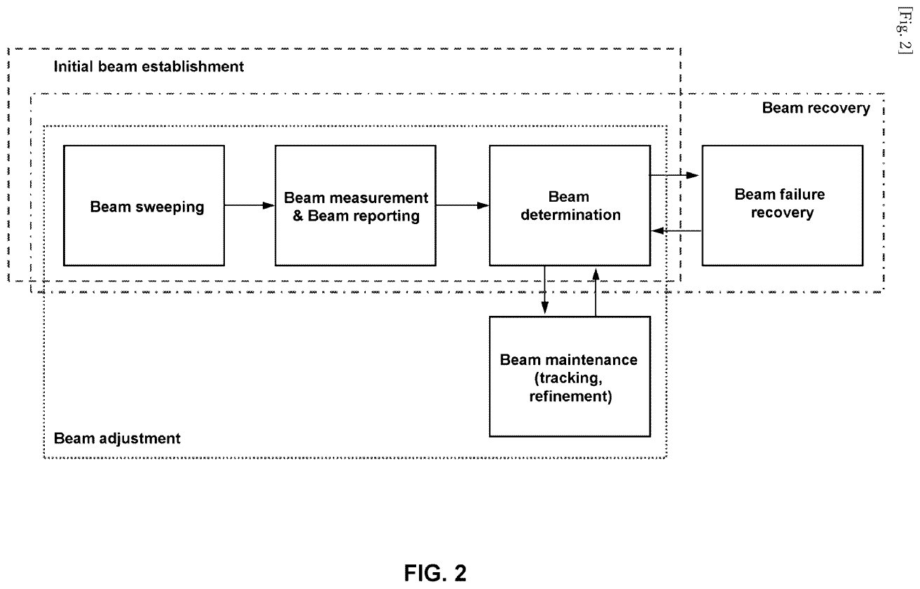

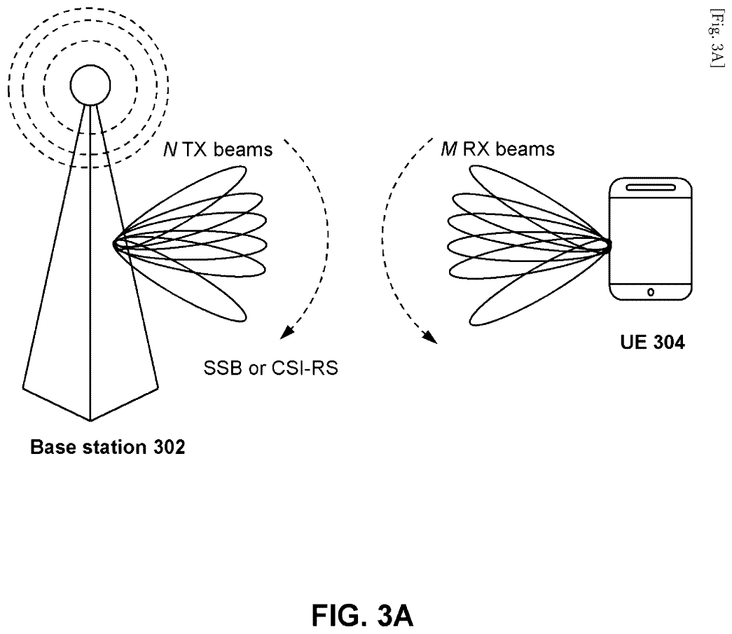

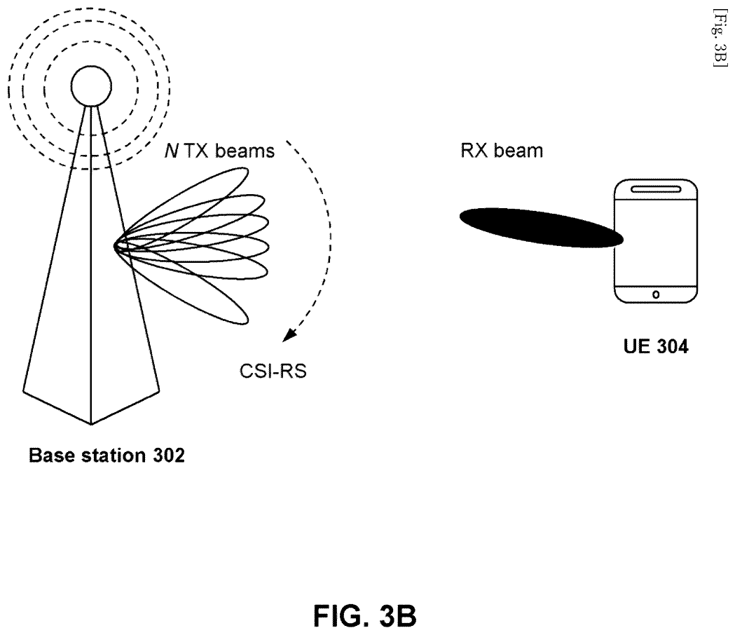

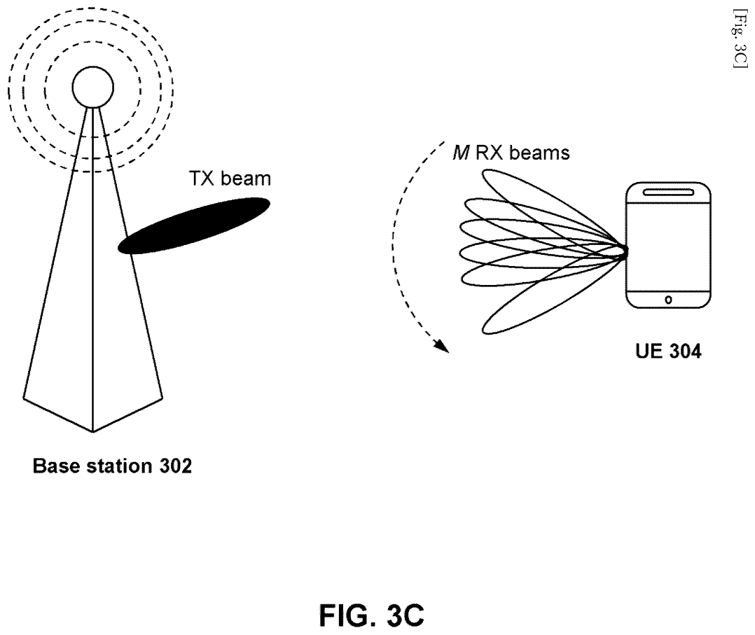

FIG. 2 is a schematic diagram illustrating three phases of beam management, consistent with some embodiments of the present disclosure. Referring to FIG. 2, beam management may include three phases: (1) initial beam establishment, (2) beam adjustment, and (3) beam (link) recovery. For these three phases, six steps are involved, they are: a beam sweeping step, a beam measurement step, a beam reporting step, a beam determination step, a beam maintenance step, and a beam failure recovery step. The beam maintenance step may include a beam tracking and/or a beam refinement process. The initial beam establishment phase may include the beam sweeping step, the beam measurement step, the beam reporting step, and the beam determination step. The beam adjustment phase may include the beam sweeping step, the beam measurement step, the beam reporting step, the beam determination step, and the beam maintenance step. The beam (link) recovery phase may include the beam sweeping step, the beam measurement step, the beam reporting step, the beam determination step, and the beam failure recovery step. The beam sweeping may include three procedures: procedure-1,procedure-2, and procedure-3 as described below in connection with FIGS. 3A, 3B, 3C, 4, and 5.

FIG. 3A is a schematic diagram illustrating the procedure-1 (P1) of beam sweeping; FIG. 3B is a schematic diagram illustrating the procedure-2 (P2) of beam sweeping; and FIG. 3C is a schematic diagram illustrating the procedure-3 (P3) of beam sweeping, consistent with some embodiments of the present disclosure. Procedure-1 is for downlink. Referring to FIG. 3A, a communication system includes a base station 302 and a UE 304. To obtain beam alignment between the Tx beam of the base station 302 and the Rx beam of UE 304, the base station 302 may transmit reference signals, such as CSI-RS or SSBs with different sequences at different beam directions, for example, by performing Tx beam sweeping. The base station 302 may have N Tx beams and the UE 304 may have M Rx beams, where N and M are natural numbers. Each of N Tx beams is transmitted M times from the base station 302 so that the UE 304 can receive the Tx beam using M multiple beams per Tx beam. Thus, base station 302 transmits N×M CSI-RS or SSB signals in total. The UE 304 may measure the quality of the received CSI-RS or SSB signals, for example, reference signal received power (RSRP) for all the CSI-RS or SSB signals and may select the best beam. The UE 304 may further report the selected beam to the base station 302.

Referring to FIG. 3B, in the procedure-2, the base station 302 transmits N beamforming CRI-RS signals to the UE 304. The UE 304 receives a set of N Tx beams transmitted from the base station 302 using the same Rx beam. This Rx beam may correspond (e.g., be a reciprocal) to the beam selected in the procedure-1.

Referring to FIG. 3C, in the procedure-3, the UE 304 sweeps M Rx beams. The base station 302 arranges M beamforming CSI-RS transmissions with the same Tx beam for the UE 304 to sweep over M Rx beams.

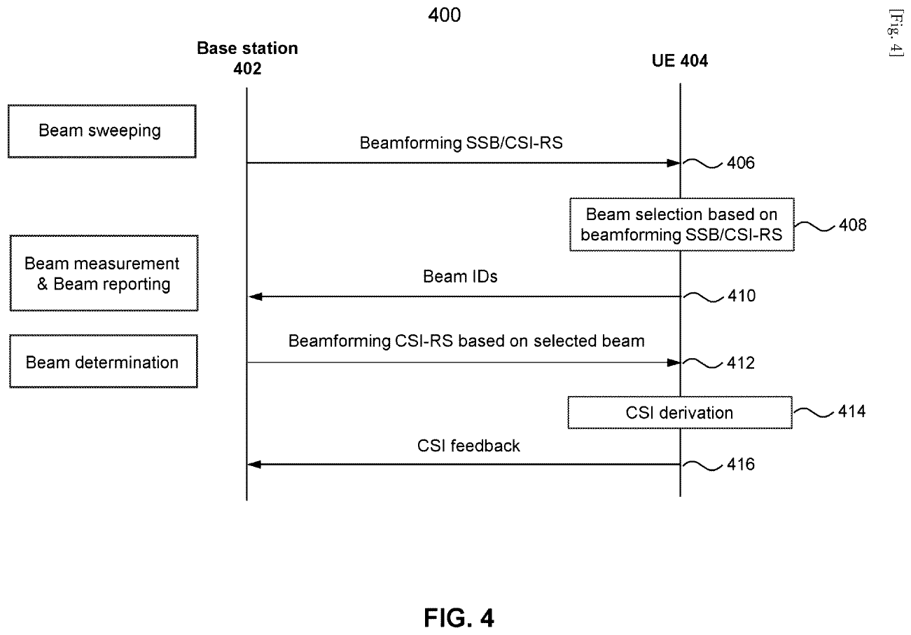

FIG. 4 is a schematic diagram illustrating a method for beam management based on downlink SSB or CSI-RS signals, consistent with some embodiments of the present disclosure. Referring to FIG. 4, a method 400 for beam management is initiated by a base station 402. The method 400 include a step 406 of transmitting SSB or CSI-RS signals for beam sweeping. For example, the base station 402 may transmit SSB or CSI-RS signals to a UE 404 using Tx beamforming. The SSB or the CSI-RS signals may be swept and transmitted in different angular directions. The UE may use an Rx beam (e.g., a wide beam) to receive the SSB or the CSI-RS signals. The method 400 includes a step 408 of performing beam selection based on the beamforming SSB or CSI-RS. For example, the UE 404 may measure the quality of the received SSB or CSI-RS signals. The UE 404 may measure RSRP and/or signal-to-noise ratio (SNR) for the received signals and select the best beam. The best beam may have the highest RSRP and/or SNR value. In some embodiments, the UE may select more than one beam (e.g., top four beams). The method 400 includes a step 410 of reporting one or more identifications (IDs) of the selected one or more beams. For example, based on the beam measurement on the received SSB or CSI-RS, the UE 404 may report one or more IDs of the one or more selected beams to the base station 402. The method 400 includes a step 412 of transmitting beamforming CSI-RS based on the selected one or more beams. For example, the base station 402 may only focus on the beam directions with the beam IDs reported by the UE for transmissions (known as the selected beams) and transmit beamforming CSI-RS based on the selected beams. The method 400 includes a step 414 of performing CSI derivation. For example, the UE 404 may use an Rx beam to receive the base station's refined downlink CSI-RS beam sweeping and derive the CSI on these selected beams. The UE 404 may estimate channel state of the downlink channel. The method 400 includes a step 416 of transmitting the CSI to the base station as feedback. For example, after performing the CSI derivation, the UE 404 may transmit the CSI to the base station 402 as feedback.

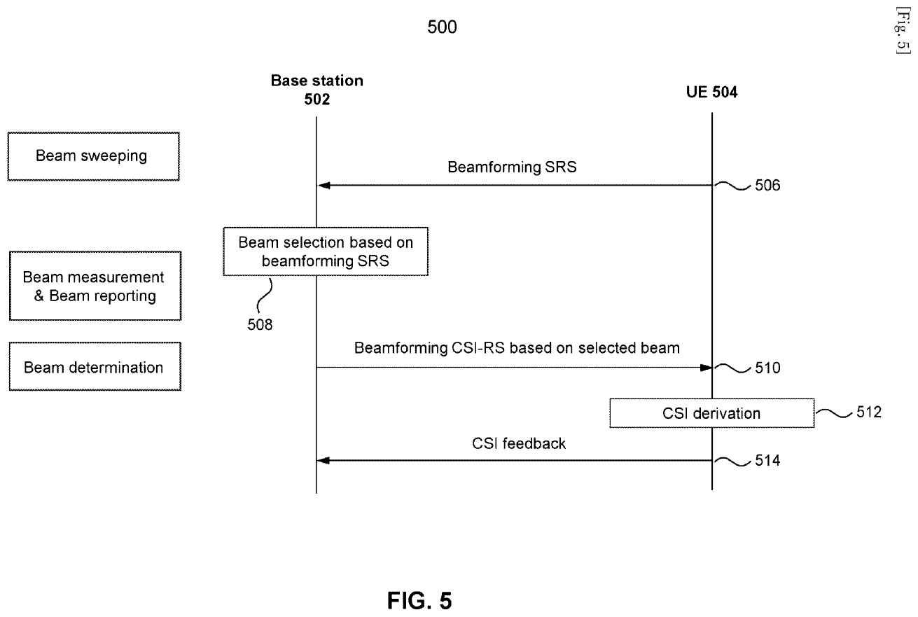

FIG. 5 is a schematic diagram illustrating a method for beam management based on uplink SRS signals, consistent with some embodiments of the present disclosure. Referring to FIG. 5, a method 500 for beam management is initiated by a UE 504 through transmitting the SRS signals for beam sweeping. The method 500 include a step 506 of transmitting SRS signals for beam sweeping. For example, the UE 504 may transmit SRS signals to a base station 502 using Tx beamforming. The SRS signals may be swept and transmitted in different angular directions. The base station 502 may use an Rx beam (e.g., a wide beam) to receive the SRS signals. The method 500 includes a step 508 of performing beam selection based on the beamforming SRS. For example, the base station 502 may measure the quality of the received SRS signals. The base station 502 may measure RSRP and/or SNR for the received SRS signals and select the best beam. The best beam may have the highest RSRP and/or SNR value. In some embodiments, the base station 502 may select more than one beam (e.g., top four beams) and may focus on the selected beams. The method 500 includes a step 510 of transmitting beamforming CSI-RS based on the selected beam. For example, the base station 502 transmits beamforming CSI-RS using the selected beam. The method 500 includes a step 512 of performing CSI derivation. For example, the UE 504 may use an Rx beam to receive the base station's CSI-RS beam sweeping and derive the CSI on these selected beams. For example, the UE 504 may estimate the channel state of the downlink channel. The method 500 includes a step 514 of transmitting the CSI to the base station as feedback. For example, after performing the CSI derivation, the UE 504 may transmit the CSI to the base station 502 as feedback.

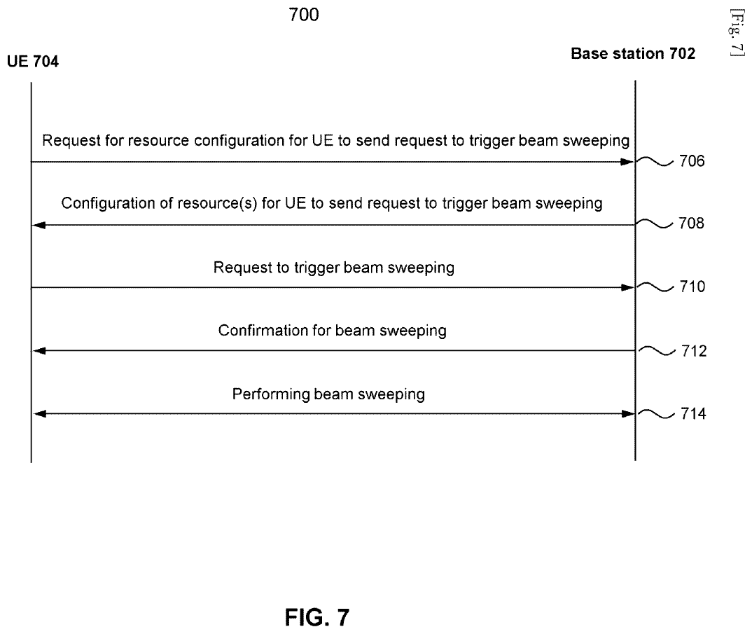

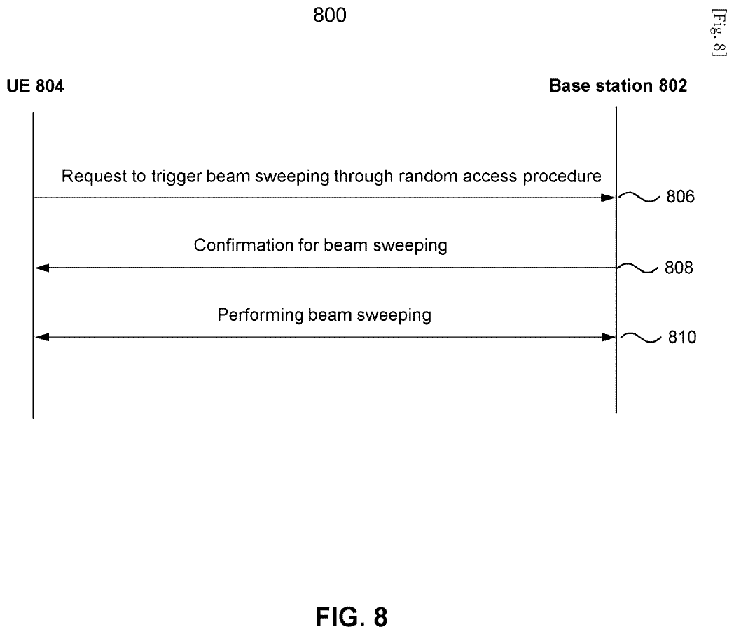

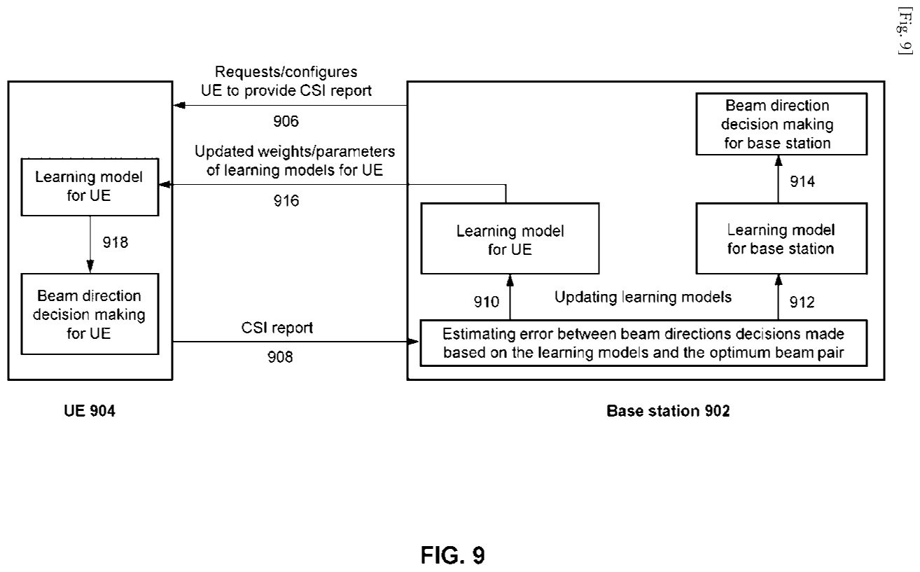

In the method 400 of FIG. 4 and the method 500 of FIG. 5, the periodicity of CSI report is configured by the base station (the base station 402 or the base station 502). Thus, only the base station can initiate the beam sweeping, for example, through the radio resource control (RRC) signaling, and the UE (the UE 404 or the UE 504) cannot initiate the beam sweeping. This may limit the performance of beam management because there is no guarantee that the base station always initiates beam sweeping whenever the UE needs to perform beam sweeping. At least some embodiments of the present disclosure provide solutions to this issue. For example, at least some embodiments of the present disclosure provide methods for beam management that allow for a UE to initiate beam sweeping, as discussed with respect to FIG. 7 and FIG. 8 below. Also, another issue in beam management is that the overheads involved in beam management are significant. The overheads may include the amount of transmitted reference signals, the number of beam sweepings performed, and the provision of the CSI feedback. At least some embodiments of the present disclosure provide solutions to this issue. For example, at least some embodiments of the present disclosure provide beam management methods in which AI/ML are utilized, thereby reducing the overheads in beam management, as discussed below with respect to FIGS. 9-12.

In some embodiments, AI/ML methods involving labeled datasets are utilized in beam management. For these embodiments, there is a supervisor responsible for collecting and labeling the datasets. The labeled datasets are further provided and are deployed to a base station and/or a UE.

In some embodiments, the AI/ML methods without labeled datasets are utilized in beam management. For these embodiments, the base station and/or the UE collect data and train the model on their own. The present disclosure describes the application of the learning methods in beam management as exemplary embodiments. However, the application of the AI/ML methods is not so limited. For example, the concept and the procedures of the AI/ML methods without labeled datasets described in this disclosure can be applied to any other field. For the AI/ML methods without labeled datasets, there can be two design scenarios: scenario-1 and scenario-2 as described below.

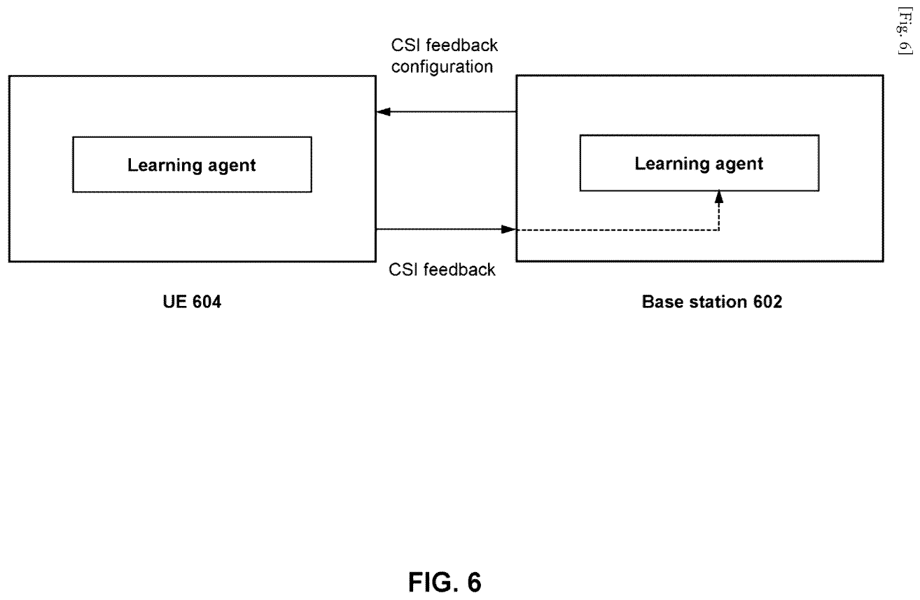

FIG. 6 is a schematic diagram illustrating scenario-1 of the AI/ML methods without labeled datasets, consistent with some embodiments of the present disclosure. Referring to FIG. 6, in the scenario-1, at least one learning agent is included in a base station 602 and at least one learning agent is included in a UE 604. In some embodiments, the base station 602 and the UE 604 make the beam management decision individually. In some embodiments, the learning agent in the base station 602 may take the responsibility of making the decision on and/or predicting the beam directions at the base station 602. In some embodiments, the learning agent in the base station 602 may infer assistance information for beam management. The assistance information may include a position of the UE 604, an orientation of the UE 604, a speed of the UE 604, a likelihood of blockage of a beam, one or more beam angles, a likelihood of measurement on the signals transmitted between the UE 604 and the base station 602, etc. In some embodiments, the learning agent in the UE 604 may take the responsibility of making decision on and/or predicting the beam direction at the UE 604. In some embodiments, the learning agent in the base station 602 may infer assistance information for beam management. The assistance information may include a position of the base station 602, an orientation of the base station 602, a speed of the base station 602, a likelihood of blockage of a beam, one or more beam angles, a likelihood of measurement on the signals transmitted between the UE 604 and the base station 602, etc. The learning agent in the base station 602 and the learning agent in the UE 604 make the decisions and/or predictions individually.

As shown in FIG. 6, the learning agent in the UE 604 and the learning agent in the base station 602 make the beam direction decisions and/or predictions individually. To train and update the learning model, each learning agent should know the true optimum beam pair so as to further refine the beam direction decisions and/or predictions. For this purpose, beam sweeping may be performed. However, as mentioned above, in the current beam management methods, only the base station has the capability to trigger beam sweeping. In this case, the learning agent in the base station 602 should be able to capture the true optimum beam pair. However, the UE 604 cannot trigger beam sweeping. The UE 604 may capture the optimum beam pair through the beam sweeping triggered by the base station 602. For example, as shown in FIG. 6, the base station 602 may provide CSI feedback configuration to the UE 604 so that the UE 604 can provide CSI feedback to the base station 602. The CSI feedback configuration provided to the UE 604 may include an explicit indication for beam sweeping. Alternatively, the CSI feedback configuration transmitted from the base station 602 to the UE 604 can implicitly inform the UE 604 to perform beam sweeping. However, since the transmission of the CSI configuration is decided by the base station, beam sweeping may not be always triggered by the base station 602 as whenever the UE 604 needs. Consequently, the performance of beam direct decisions and/or predictions may be limited. At least some embodiments of the present disclosure provide methods for beam management that allow for a UE to initiate beam sweeping, as discussed with respect to FIG. 7 and FIG. 8 below.

In the scenario-2, the base station 602 and the UE 604 make the beam management decision jointly. In this scenario, the base station 602 can make the joint decision and/or prediction or model training for both the base station 602 and the UE 604. Alternatively, the UE 604 can make the joint decision and/the prediction or model training for both the base station 602 and the UE 604. In this scenario, there may be an issue as to which one (the base station or the UE) should perform the joint beam management and how to perform the joint beam management. At least some embodiments of the present disclosure address the above-described issues in the scenario-2, as discussed with respect to FIGS. 9-12 below.

FIG. 7 is a schematic diagram illustrating a beam management method, consistent with some embodiments of the present disclosure. Referring to FIG. 7, a method 700 includes a step 706 of transmitting a request for a resource configuration for the UE 704 to send a request to trigger a beam sweeping. For example, the UE 704 transmits to a base station 702 one or more requests for a configuration of one or more resources to be used by the UE 704 to transmit one or more requests to trigger a beam sweeping. In some embodiments, the UE 704 transmits the one or more requests for the configuration of the one or more resources to be used by the UE 704 through a random access procedure.

The method 700 includes a step 708 of receiving a configuration of resource(s) for the UE 704 to send a request to trigger a beam sweeping. For example, after receiving from the UE 704 the one or more requests for configuration of the one or more resources to be used by the UE 704, the base station 702 configures the one or more resources for the UE 704. The base station 702 further transmits the configuration to the UE 704 so that the UE 704 receives the configuration of the one or more resources and uses the one or more resources. In some embodiments, the base station 702 transmits the configuration of the one or more resources at least through a message 4 (Msg4) of the random access procedure. In some embodiments, the base station 702 transmits the configuration of the one or more resources via at least one of: an RRC signal, medium access control (MAC) control element (CE), or downlink control information (DCI). In some embodiments, the base station 702 may transmit the configuration of the one or more resources to be used by the UE 704 periodically, semi-periodically, or aperiodically. For example, in an embodiment, the base station 702 may transmit periodic RRC signals or semi-periodic RRC signals to indicate the periodicity or the semi-periodicity, respectively. In this embodiment, the base station 702 may also transmit MAC CE or DCI to activate and/or deactivate the resource configuration at the UE 704. In an embodiment, the base station 702 may transmit aperiodic MAC CE or DCI for the configuration of the one or more resources.

The method 700 includes a step 710 of transmitting a request to trigger a beam sweeping. For example, upon receiving the configuration of the one or more resources from the base station 702, the UE 704 transmits to the base station 702 the one or more requests to trigger the beam sweeping on the one or more resources configured for the UE 704. In some embodiments, the one or more requests to trigger the beam sweeping may include at least one of: one or more desired occasions to perform the beam sweeping, or one or more configurations for performing the beam sweeping. In some embodiments, the UE 704 may send the one or more requests to trigger the beam sweeping through a beam pair identified during a random access procedure or other identified beam pairs.

The method 700 includes a step 712 of receiving a confirmation for the beam sweeping by the UE 704. For example, after receiving the one or more requests to trigger a beam sweeping sent from the UE 704, the base station 702 transmits a confirmation for the beam sweeping and the UE 704 receives the confirmation. In some embodiments, the confirmation may indicate (confirm) the occasions and/or configurations to perform beam sweeping included in the one or more requests to trigger beam sweeping. In some embodiments, the confirmation for the beam sweeping received from the base station 702 may include at least one of: (1) whether the base station 702 will use CSI-RS or SSB to perform the beam sweeping, (2) one or more sets of beam directions for the beam sweeping, or (3) one or more widths of one or more beams for the beam sweeping.

The method 700 includes a step 714 of performing a beam sweeping. For example, after the UE 704 receives the confirmation for the beam sweeping, the UE 704 may initiate the beam sweeping and both the base station 702 and the UE 704 may perform beam sweeping. The UE 704 may perform the beam sweeping at least using SRS signals. The base station 702 may perform the beam sweeping using CSI-RS or SSB signals. In this way, the UE 702 actively initiates a beam sweeping.

FIG. 8 is a schematic diagram illustrating a method for beam management, consistent with some embodiments of the present disclosure. Referring to FIG. 8, a method 800 includes a step 806 of transmitting a request to trigger a beam sweeping through a random access procedure. For example, a UE 804 transmits to a base station 802 one or more requests to trigger a beam sweeping through a random access procedure. In some embodiments, the one or more requests to trigger the beam sweeping may include at least one of: one or more desired occasions to perform the beam sweeping, or one or more configurations for performing the beam sweeping.

The method 800 includes a step 808 of receiving a confirmation for the beam sweeping. For example, after receiving the one or more requests to trigger a beam sweeping sent from the UE 804, the base station 802 transmits a confirmation for the beam sweeping and the UE 804 receives the confirmation. The confirmation may confirm the occasions and/or configurations to perform beam sweeping included in the one or more requests to trigger beam sweeping. In some embodiments, the confirmation for the beam sweeping transmitted from the base station 802 may include at least one of: (1) whether the base station 802 will use CSI-RS or SSB to perform the beam sweeping, (2) one or more sets of beam directions for the beam sweeping, or (3) one or more widths of one or more beams for the beam sweeping.

The method 800 includes a step 810 of performing a beam sweeping. For example, after the UE 804 receives the confirmation for the beam sweeping, the UE 804 may initiate the beam sweeping and both the base station 802 and the UE 804 may perform beam sweeping. The UE 804 may perform the beam sweeping at least using SRS signals. The base station 802 may perform the beam sweeping using CSI-RS or SSB signals. In this way, the UE 802 actively initiates beam sweeping.

FIG. 9 is a schematic diagram illustrating a beam management method, consistent with some embodiments of the present disclosure. Referring to FIG. 9, a base station 902 includes a learning model for UE and a learning model for base station. The learning model for UE is for beam management for a UE 904 and the learning model for base station is for beam management for the base station 902. The base station 902 takes the responsibility of training both learning models. The process of beam management performed by the UE 904 and the base station 902 may include two stages: an initial stage and a subsequent stage.

At an initial stage of the beam management, the base station 902 and the UE 904 may adopt one or more learning models based on an agreement. For example, in some embodiments, a certain number of structures for learning models are provided as standards. The base station 902 may support all or a part of the structures in the standards and inform the supported structures for learning models to the UE 904. For example, base station 902 may inform the supported structures for learning models via a master information block (MIB) or a system information block (SIB). The UE 904 may also support all or a part of structures in the standards and inform the supported structures for learning models to the base station 902. For example, the UE 902 may inform the supported structures for learning models as UE capability information transmitted via an RRC signal.

At the initial stage, in some embodiments, the base station 902 (or a core network) may determine which structures for learning models to be adopted and may inform the adopted structures for learning models to the UE 904. In some embodiments, the UE 904 may determine which structures for learning models to be adopted and may inform the adopted structures of learning models to the base station 902 (or the core network). In the case that the UE 904 informs the adopted structures of learning models to the base station 902, the base station 902 may allocate radio resources for the UE 904 to send the information regarding the adopted structures of learning models to the base station 902. In some embodiments, the UE 904 and the base station 902 may adopt one or more structures for learning models specified in standards (e.g., the 3GPP standard).

At the initial stage, in some embodiments, the base station 902 (or the core network) may determine adopted weights and/or parameters for the learning models and inform the adopted weights and/or parameters for the learning models to the UE 904. In some embodiments, the UE 904 may determine the adopted weights and/or parameters for the learning models and inform the adopted weights and/or parameters for the learning models to the base station 902 (or the core network). In the case the UE 904 informs the adopted weights and/or parameters for the learning models to the base station 902, the base station 902 (or the core network) may allocate radio resources for the UE 904 to send the information regarding the adopted weights and/or parameters for the learning models to the base station 902. In some embodiments, the UE 904 and the base station 902 may adopt weights and/or parameters for the learning models specified in standards (e.g., the 3GPP standard).

At the initial stage, in some embodiments, the base station 902 and the UE 904 may adopt one or more neural networks. In these embodiments, the structure of the learning models may be specified based on at least one of: a number of neural network layers, a number of neural nodes in each neural network layer, one or more connection structures (e.g., fully connected, etc.) between the neural network layers, one or more types of the neural network layers (e.g., pooling layer, convolutional layer, etc.), one or more types of connections (e.g., forward connection, convolutional connection, etc.) of the neural nodes, one or more types of computing operation in each neural node (e.g., sigmoid function), a number of weights of the one or more neural networks, a number of parameters of the one or more neural networks, one or more types of weights (e.g., real number, complex number, integer number, floating number, etc.) of the one or more neural networks, one or more types of parameters (e.g., real number, complex number, integer number, floating number, etc.) of the one or more neural networks, or one or more loss functions of the one or more neural networks. The one or more loss functions may be used for measuring a difference and/or an error of the one or more neural networks. In some embodiments, the base station 902 and the UE 904 may adopt one or more deep neural networks.

At the initial stage, in some embodiments, the base station 902 and the UE 904 may adopt one or more (deep) neural networks with generative advisory networks (GAN). In these embodiments, in addition to the structure of the learning models for the (deep) neural networks mentioned above, the structure of the learning models may also include at least one of a generator or a discriminator, and the interconnection of the generator, the discriminator, and the neural networks may also be specified.

At the initial stage, in some embodiments, the base station 902 and the UE 904 may adopt one or more deep reinforcement learning (DRL) methods. In these embodiments, the structure of the learning models may be specified based on at least one of: a state space of the DRL, an action space of the DRL, one or more reward functions of the DRL, a size of replay memory and a content (experience) in replay memory, or a minimum batch size for sampling in a replay memory.

Referring to FIG. 9, at the subsequent stage, the base station 902 has a learning model for the UE 904 and a learning model for the base station 902, and the UE 904 only has its own learning model. At a step 906, the base station 902 requests or configures the UE 904 to provide one or more CSI reports. For example, the base station 902 may send one or more requests to the UE 904, and the one or more requests may include a configuration for one or more CSI measurements to be performed by the UE 904. At a step 908, the UE 904 performs the CSI measurements and transmits one or more CSI reports to the base station 902. Based on the received one or more CSI reports, the base station 902 may determine an optimum beam pair. For example, the base station 902 may trigger a beam sweeping to identify the optimum beam pair. The optimum beam pair may be the beam pair having the highest measurement value in the CSI reports. The base station 902 further estimates an error or a difference between the direction of the optimum pair and the one or more beam directions determined based on the learning model for UE and/or the learning model for base station. Based on the determined error or the difference, at a step 910, the base station 902 trains and updates the weights and/or parameters of the learning model for UE included in the base station 902. Similarly, at a step 912, the base station 902 trains and updates the weights and/or parameters of the learning model for base station included in the base station 902. At a step 914, based on the updated learning model for base station, the base station 902 estimates beam directions at a current time and/or a future time, and makes a decision for beam directions for the base station 902. At a step 916, the base station 902 transmits to the UE 904 at least one of: the updated weights of the learning model for UE, the updated parameters of the learning model for UE, or the updated learning model for UE. The base station 902 may configure one or more resources for transmitting the updated weights and/or parameters, or the updated learning model for UE to the UE 904. The base station 902 may further indicate the configured resources to the UE 904. The UE 904 may estimate beam directions based on the updated weights and/or parameters, or the updated learning model for UE received from the base station 902. At a step 918, the UE 904 further makes a decision on the beam directions for the UE 904 at a current time and/or a future time.

In some embodiments, the base station 902 may train and updates the weights and/or parameters of the learning model for UE and the weights and/or parameters of the learning model for base station periodically. In some embodiments, the base station 902 may train and update the weights and/or parameters of the learning model for UE and the weights and/or parameters of the learning model for base station, when the measurement results of the one or more CSI reports received from the UE 904 are lower than a certain threshold.

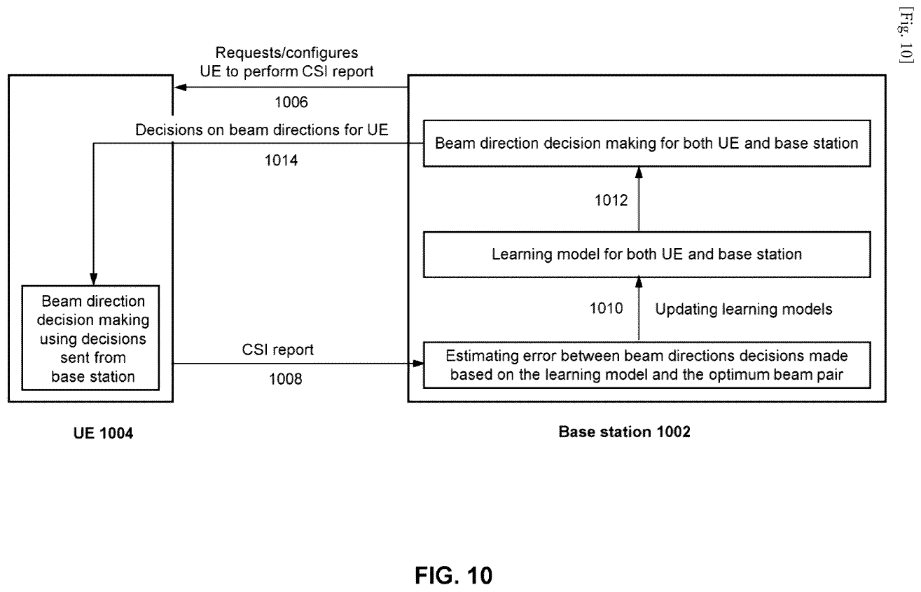

FIG. 10 is a schematic diagram illustrating a beam management method, consistent with some embodiments of the present disclosure. Referring to FIG. 10, a base station 1002 includes a learning model for both UE and base station, and makes beam direction decisions and/or predictions for both the UE 1004 and the base station 1002. In some embodiments, the learning model for both UE and base station can be two or more learning models. The UE 1004 does not have a learning model. The beam management method in FIG. 10 may include an initial stage and a subsequent stage. The operations of the base station 1002 and the UE 1004 at the initial stage are similar to those of the base station 902 and the UE 904 of FIG. 9. For the sake of brevity, descriptions of the operations of the base station 1002 and the UE 1004 at the initial stage are omitted here. The subsequent stage of the beam management is described below with respect to FIG. 10.

Referring to FIG. 10, at a step 1006, the base station 1002 requests or configures the UE 1004 to provide one or more CSI reports. For example, the base station 1002 may send one or more requests to the UE 1004, and the one or more requests may include a configuration for one or more CSI measurements to be performed by the UE 1004. At a step 1008, the UE 1004 performs the CSI measurements and transmits the one or more CSI reports to the base station 1002. Based on the received one or more CSI reports, the base station 1002 determines an optimum beam pair. For example, the base station 1002 may initiate beam sweeping to determine the optimum beam pair. The base station 1002 further estimates an error or a difference between the one or more beam directions determined based on the learning model for both the UE and base station and the direction of the optimum pair. Based on the determined error or difference, at a step 1010, the base station 1002 trains and updates the weights and/or parameters of the learning model for both UE and base station. At a step 1012, based on the updated learning model for both UE and base station, the base station 1002 estimates beam directions for both the base station 1002 and the UE 1004, and makes a decision for beam directions for both the base station 1002 and the UE 1004. The beam directions for the base station 1002 and the beam directions for the UE 1004 may be the beam directions at a current time and/or a future time. At a step 1014, the base station 1002 sends to the UE 1004 the decisions on the beam directions for the UE 1004. The base station 1002 may configure one or more resources for sending the decisions on the beam directions to the UE 1004, and may further indicate the configured resources to the UE 1004. The UE 1004 adopts the decisions on the beam directions sent from the base station 1002. Based on the decisions on the beam directions received from the base station 1002, the UE 1004 may adjust the decision or make its own decision on its beam directions.

In some embodiments, the base station 1002 may update the decisions on beam directions for both the base station 1002 and the UE 1004 periodically. In some embodiments, the base station 1002 may update the decisions on beam directions for both the base station 1002 and the UE 1004 when the measurement results of the CSI reports are lower than a certain threshold.

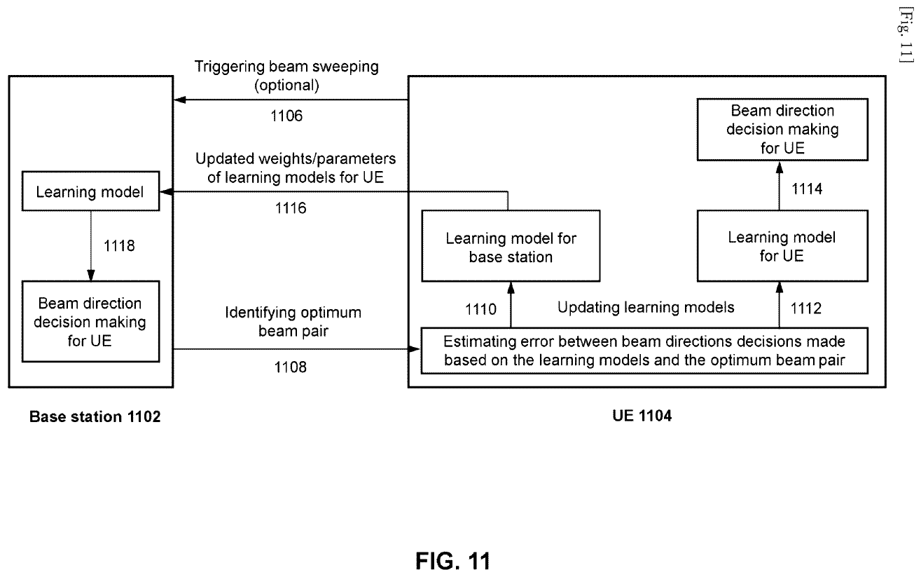

FIG. 11 is a schematic diagram illustrating a beam management method, consistent with some embodiments of the present disclosure. As shown in FIG. 11, a UE 1104 has a learning model for UE and a learning model for base station, and the UE 1104 is responsible for training the learning models for the UE 1104 and the base station 1102. On the other hand, the base station 1102 only has its own learning model. The beam management method in FIG. 11 may include an initial stage and a subsequent stage. The operations for the base station 1102 and the UE 1104 at the initial stage are similar to those of the base station 902 and the UE 904 of FIG. 9. For the sake of brevity, descriptions of the operations of the base station 1002 and the UE 1004 at the initial stage are omitted here.

Referring to FIG. 11, at a step 1106, the UE 1104 may trigger a beam sweeping. For example, the UE 1104 may initiate a beam sweeping by sending to the base station 1102 a request to configure resources for the UE 1104 to send a request to trigger a beam sweeping, as described with respect to FIG. 7 or FIG. 8 above. In some embodiments, the step of triggering beam sweeping by the UE 1104 is omitted. At a step 1108, the UE 1104 may identify an optimum beam pair. In some embodiments, the UE 1104 may identify the optimum beam pair by performing the beam sweeping that is triggered at the step 1106. In some embodiments, the UE 1104 may identify the optimum beam pair through observing SSB and/or CSI-RS transmitted from the base station 1102, or through a beam sweeping triggered by the base station 1102. The UE 1104 further estimates an error or a difference between the optimum beam pair and the one or more beam directions determined based on the learning model for UE and/or the learning model for base station. Based on the determined error or the difference, at a step 1112, the UE 1104 trains and updates the weights and/or parameters of the learning model for UE. Similarly, at a step 1110, the UE 1104 trains and updates the weights and/or parameters of the learning model for base station included in the UE 1104. At a step 1114, based on the updated learning model for UE, the UE 1104 estimates beam directions at a current time and/or a future time, and makes a decision for beam directions for the UE 1104. At a step 1116, the UE 1104 sends to the base station 1102 at least one of: the updated weights of the learning model for base station, the updated parameters of the learning model for base station, or the updated learning model for base station. The base station 1102 may configure one or more resources for the UE 1104 to send the updated weights/parameters or the updated learning model for base station. The base station 1102 may further indicate the configured resources to the UE 1104 so that the UE 1104 can use the resources for transmission. At a step 1118, the base station 1102 uses the updated weights/parameters or the updated learning model for base station received from the UE 1104 to estimate the beam directions for a current time and/or a future time and makes a decision on beam directions for the base station 1102.

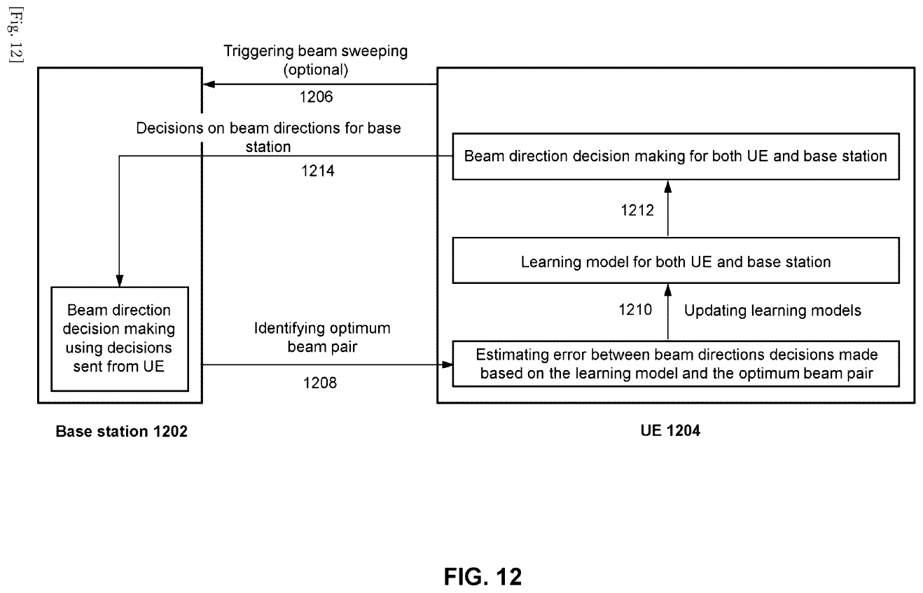

FIG. 12 is a schematic diagram illustrating a beam management method, consistent with some embodiments of the present disclosure. As shown in FIG. 12, a UE 1204 includes a learning model for both UE and base station, and makes beam direction decisions and/or predictions for both the UE 1204 and the base station 1202. The base station 1202 does not have a learning model. In some embodiments, the learning model for both UE and base station can be two or more learning models. The UE 1204 not only trains the learning models for both the base station 1202 and the UE 1204, but also makes beam direction decisions and/or predictions for both the base station 1202 and the UE 1204. The beam management method of FIG. 12 may include an initial stage and a subsequent stage. The operations of the base station 1202 and the UE 1204 at the initial stage are similar to those of the base station 902 and the UE 904 of FIG. 9. For the sake of brevity, descriptions of the operations of the base station 1202 and the UE 1204 are omitted here.

Referring to FIG. 12, at a step 1206, the UE 1204 may trigger a beam sweeping. For example, the UE 1204 may initiate a beam sweeping by sending to the base station 1202 a request to configure resources for the UE 1204 to send a request to trigger a beam sweeping, as described with respect to FIG. 7 or FIG. 8 above. In some embodiments, the step of triggering beam sweeping by the UE 1204 is omitted. At a step 1208, the UE 1204 may identify an optimum beam pair. In some embodiments, the UE 1204 may identify the optimum beam pair by performing the beam sweeping that is triggered at the step 1206. In some embodiments, the UE 1204 may identify the optimum beam pair through observing SSB and/or CSI-RS transmitted from the base station 1202, or through a beam sweeping triggered by the base station 1202. The UE 1204 further estimates an error or a difference between the one or more beam directions determined based on the learning model for UE and the direction of the optimum pair. Based on the determined error or difference, at a step 1210, the UE 1204 trains and updates the weights and/or parameters of the learning model for both UE and base station. At a step 1212, based on the updated learning model for both UE and base station, the UE 1204 determines beam directions for both the base station 1202 and the UE 1204, and makes a decision for beam directions for both the base station 1202 and the UE 1204. The beam directions for the base station 1202 and the beam directions for the UE 1204 may be the beam directions at a current time and/or a future time. At a step 1214, the UE 1204 sends to the base station 1202 the decisions on the beam directions for the base station 1202. The base station 1202 may configure one or more resources for sending the decisions on the beam directions to the base station 1202, and indicate the configured resources to the UE 1204. The base station 1202 adopts the decisions on the beam directions received from the UE 1204. Based on the decisions on the beam directions received from the UE 1204, the base station 1202 may adjust the decision or make its own decision on its beam directions.

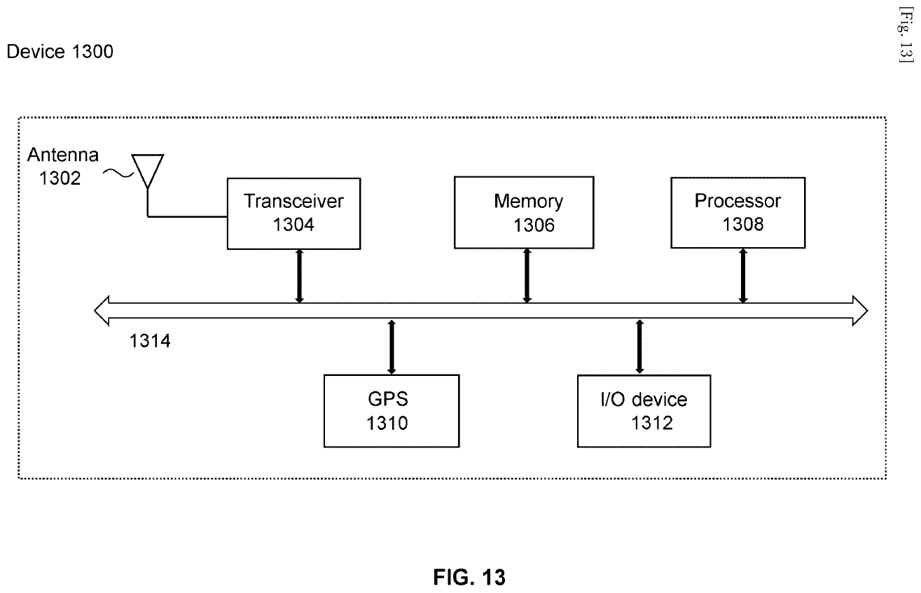

FIG. 13 is a block diagram of a device 1300, consistent with some embodiments of the present disclosure. In some embodiments, the device 1300 may be a UE. For example, the device 1300 may be the UE 704 of FIG. 7 or the UE 804 of FIG. 8 that triggers a beam sweeping. For another example, the device 1300 may be the UE 904 of FIG. 9 or the UE 1004 of FIG. 10 that receives from a base station updated weights and/or parameters of a learning model for the UE determined by the base station, or decisions on beam directions determined by the base station for the UE. For another example, the device 1300 may be the UE 1104 of FIG. 11 or the UE 1204 of FIG. 12 that includes one or more learning models for the UE and a base station and provides to the base station updated weights and/or parameters of the learning models, or decisions on the beam directions for the base station. The UE may be mounted in a moving vehicle or in a fixed position. The UE may take any form, including but not limited to, a vehicle, a component mounted in a vehicle, a road-side unit, a laptop computer, a wireless terminal including a mobile phone, a wireless handheld device, or wireless personal device, or any other form. In some embodiments, the device 1300 may be a base station, such as the base station 702 of FIG. 7, the base station 802 of FIG. 8, the base station 902 of FIG. 9, the base station 1002 of FIG. 10, the base station 1102 of FIG. 11, or the base station 1202 of FIG. 12. In these embodiments, the device 1300 may take the form of a base station (or a component of a base station) or any network node.

Referring to FIG. 13, the device 1300 may include antenna 1302 that may be used for transmission or reception of electromagnetic signals to/from one or more other devices (e.g., base stations or UEs). The antenna 1302 may include one or more antenna elements and may enable different input-output antenna configurations, for example, multiple input multiple output (MIMO) configuration, multiple input single output (MISO) configuration, and single input multiple output (SIMO) configuration. In some embodiments, the antenna 1302 may include multiple (e.g., tens or hundreds) antenna elements and may enable multi-antenna functions such as beamforming. In some embodiments, the antenna 1302 is a single antenna.

The device 1300 may include a transceiver 1304 that is coupled to the antenna 1302. The transceiver 1304 may be a wireless transceiver at the device 1300 and may communicate bi-directionally with other devices (e.g., base stations or UEs). For example, in some embodiments, the device 1300 is a UE and the transceiver 1304 may receive/transmit wireless signals from/to a base station via downlink/uplink communication. The transceiver 1304 may also receive/transmit wireless signals from/to another UE or road side unit via sidelink communication. The transceiver 1304 may include a modem to modulate the packets and provide the modulated packets to the antenna 1302 for transmission, and to demodulate packets received from the antenna 1302.

The device 1300 may include a memory 1306. The memory 1306 may be any type of computer-readable storage medium including volatile or non-volatile memory devices, or a combination thereof. The computer-readable storage medium includes, but is not limited to, non-transitory computer storage media. A non-transitory storage medium may be accessed by a general purpose or special purpose computer. Examples of non-transitory storage medium include, but are not limited to, a portable computer diskette, a hard disk, random access memory (RAM), read-only memory (ROM), an erasable programmable read-only memory (EPROM), electrically erasable programmable ROM (EEPROM), a digital versatile disk (DVD), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable medium.

The memory 1306 may store information related to identities of the device 1300 and the signals and/or data received by the antenna 1302. The memory may also store one or more learning models for AI/ML methods. In some embodiments, the memory 1306 includes a learning model for both UE and base station. In some embodiments, the memory 1306 only includes a learning model for UE or a learning model for base station. The memory 1306 may also store post-processing signals and/or data. The memory 1306 may also store computer-readable program instructions, mathematical models, and algorithms that are used in signal processing in the transceiver 1304 and computations in a processor 1308 included in the device 1300. The memory 1306 may further store computer-readable program instructions for execution by the processor 1308 to operate the device 1300 to perform various functions described in this disclosure. In some examples, the memory 1306 may include a basic input/output system (BIOS) which may control basic hardware or software operation such as the interaction with peripheral components or devices. In some embodiments, the memory 1306 includes a learning model for UE and a learning model for base station.

The computer-readable program instructions of the present disclosure may be assembler instructions, instruction-set-architecture (ISA) instructions, machine instructions, machine-dependent instructions, microcode, firmware instructions, state-setting data, or source code or object code written in any combination of one or more programming languages, including an object-oriented programming language, and conventional procedural programming languages. The computer-readable program instructions may execute entirely on a computing device as a stand-alone software package, or partly on a first computing device and partly on a second computing device remote from the first computing device. In the latter scenario, the second, remote computing device may be connected to the first computing device through any type of network, including a local area network (LAN) or a wide area network (WAN).

The processor 1308 may include a hardware device with processing capabilities. The processor 1308 may include at least one of a general-purpose processor, a digital signal processor (DSP), a central processing unit (CPU), a microcontroller, an application specific integrated circuit (ASIC), a field programmable gate array (FPGA), a programmable logic device, a discrete gate or transistor logic component, a discrete hardware component, or other programmable logic device. Examples of the general-purpose processor include, but are not limited to, a microprocessor, any conventional processor, a controller, a microcontroller, or a state machine. In some embodiments, the processor 1308 may be implemented using a combination of devices (e.g., a combination of a DSP and a microprocessor, multiple microprocessors, one or more microprocessors in conjunction with a DSP core, or any other such configuration). The processor 1308 may receive, from transceiver 1304, downlink/uplink signals or sidelink signals and further process the signals. The processor 1308 may also receive, from transceiver 1304, data packets and further process the packets. In some embodiments, the processor 1308 may be configured to operate a memory using a memory controller. In some embodiments, a memory controller may be integrated into the processor 1308. The processor 1308 may be configured to execute computer-readable instructions stored in a memory (e.g., the memory 1306) to cause the device 1300 to perform various functions, for example, the methods as shown in FIGS. 7-12.

The device 1300 may include a global positioning system (GPS) 1310. The GPS 1310 may be used for enabling location-based services or other services based on a geographical position of the device 1300 and/or synchronization among UEs. The GPS 1310 may receive global navigation satellite systems (GNSS) signals from a single satellite or a plurality of satellite signals via the antenna 1302 and provide a geographical position of the device 1300 (e.g., coordinates of the UE 1300). In some embodiments, the GPS 1310 is omitted. In some embodiments, a timer is included.

The device 1300 may include an input/output (I/O) device 1312 that may be used to communicate a result of signal processing and computation to a user or another device. The I/O device 1312 may include a user interface including a display and an input device to transmit a user command to the processor 1308. The display may be configured to display a status of signal reception at the device 1300, the data stored at the memory 1306, a status of signal processing, and a result of computation, etc. The display may include, but is not limited to, a cathode ray tube (CRT), a liquid crystal display (LCD), a light-emitting diode (LED), a gas plasma display, a touch screen, or other image projection devices for displaying information to a user. The input device may be any type of computer hardware equipment used to receive data and control signals from a user. The input device may include, but is not limited to, a keyboard, a mouse, a scanner, a digital camera, a joystick, a trackball, cursor direction keys, a touchscreen monitor, or audio/video commanders, etc.

The device 1300 may further include a machine interface 1314, such as an electrical bus that connects the transceiver 1304, the memory 1306, the processor 1308, the GPS 1310, and the I/O device 1312.

In some embodiments, the device 1300 may be a UE that triggers a beam sweeping in a communication. The processor 1308 may be configured or programmed to execute the instructions stored in the memory 1306 to transmit, to a base station, one or more requests for a configuration of one or more resources to be used by the UE to transmit one or more requests to trigger a beam sweeping; receive, from the base station, the configuration of the one or more resources to be used by the UE to transmit the one or more requests to trigger the beam sweeping; transmit, to the base station, the one or more requests to trigger the beam sweeping on the one or more resources configured for the UE; receive, from the base station, a confirmation for the beam sweeping; and perform the beam sweeping based on the confirmation.

In some embodiments, the device 1300 may be another UE that triggers a beam sweeping in a communication. The processor 1308 may be configured or programmed to execute the instructions stored in the memory 1306 to transmit, to a base station and through a random access procedure, one or more requests to trigger a beam sweeping, the one or more requests to trigger the beam sweeping comprising at least one of: one or more desired occasions to perform the beam sweeping, or one or more configurations for performing the beam sweeping; receive, from the base station, a confirmation for the beam sweeping; and perform the beam sweeping based on the confirmation.

In some embodiments, the device 1300 may be a base station for beam management in a communication. The processor 1308 may be configured or programmed to execute the instructions stored in the memory 1306 to receive, from a UE, one or more requests for a configuration of one or more resources to be used by the UE to transmit one or more requests to trigger a beam sweeping; transmit, to the UE, the configuration of the one or more resources to be used by the UE to transmit the one or more requests to trigger the beam sweeping; receive, from the UE, the one or more requests to trigger the beam sweeping; transmit, to the UE, a confirmation for the beam sweeping; and perform the beam sweeping based on the confirmation.

In some embodiments, the device 1300 may be another base station for beam management in a communication. The processor 1308 may be configured or programmed to execute the instructions stored in the memory 1306 to receive, from a UE and through a random access procedure, one or more requests to trigger a beam sweeping, the one or more requests to trigger the beam sweeping comprising at least one of: one or more desired occasions to perform the beam sweeping, or one or more configurations for performing the beam sweeping; transmit, to the UE, a confirmation for the beam sweeping; and perform the beam sweeping based on the confirmation.

In some embodiments, the device 1300 may be another base station for beam management in a communication. The processor 1308 may be configured or programmed to execute the instructions stored in the memory 1306 to transmit, to a UE, one or more requests for one or more CSI reports, the one or more requests comprising a configuration for one or more CSI measurements to be performed by the UE; receive, from the UE, the one or more CSI reports; update one or more learning models included in the base station based on the received one or more CSI reports, the one or more learning models comprising at least one of: one or more weights, or one or more parameters; determine one or more beam directions for at least one of the base station or the UE, based on the updated one or more learning models; and transmit, to the UE, the updated one or more learning models or at least one of: updated one or more weights, or updated one or more parameters.

In some embodiments, the device 1300 may be another UE for beam management in a communication. The processor 1308 may be configured or programmed to execute the instructions stored in the memory 1306 to receive, from a base station, one or more requests for one or more CSI reports, the one or more requests comprising a configuration for one or more CSI measurements to be performed by the UE; transmit, to the base station, the one or more CSI reports; receive, from the base station, an updated learning model for the UE, or at least one of: updated one or more weights, or updated one or more parameters, of the learning model for the UE, the learning model for the UE being included in the base station and updated by the UE based on the one or more CSI reports; and determine one or more beam directions for the UE based on the updated learning model for the UE, or the at least one of: the updated one or more weights, or the updated one or more parameters, of the learning model for the UE.

In some embodiments, the device 1300 may be another UE for beam management in a communication. The processor 1308 may be configured or programmed to execute the instructions stored in the memory 1306 to receive, from a base station, one or more requests for one or more CSI reports, the one or more requests comprising a configuration for one or more CSI measurements to be performed by the UE; transmit, to the base station, the one or more CSI reports; receive, from the base station, one or more beam directions for the UE determined by a learning model included in the base station, the learning model being a learning model for both the UE and the base station; and determine a beam to be used by the UE based on the received one or more beam directions.

In some embodiments, the device 1300 may be another UE for beam management in a communication. The processor 1308 may be configured or programmed to execute the instructions stored in the memory 1306 to identify an optimum beam pair based on one or more signals received from a base station; update one or more learning models included in the UE based on the identified optimum beam pair, the one or more learning models comprising at least one of: one or more weights, or one or more parameters; determine one or more beam directions for at least one of the UE or the base station, based on the updated one or more learning models; and transmit, to the base station, the updated one or more learning models, or at least one of: updated one or more weights, or updated one or more parameters.

In some embodiments, the device 1300 may be another base station for beam management in a communication. The processor 1308 may be configured or programmed to execute the instructions stored in the memory 1306 to receive, from a UE, an updated learning model for the base station, or at least one of: updated one or more weights, or updated one or more parameters, of the learning model for the base station, the learning model for the base station being included in the UE and updated by the UE; and determine one or more beam directions for the base station based on the received updated learning model for the base station, or at least one of: the updated one or more weights, or the updated one or more parameters, of the learning model for the base station.

In some embodiments, the device 1300 may be another base station for beam management in a communication. The processor 1308 may be configured or programmed to execute the instructions stored in the memory 1306 to receive, from a UE, one or more beam directions for the base station determined by a learning model included in the UE, the learning model being a learning model for both the UE and the base station; and determine a beam for the base station based on the received one or more beam directions.

As used in this disclosure, use of the term “or” in a list of items indicates an inclusive list. The list of items may be prefaced by a phrase such as “at least one of” or “one or more of.” For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification, the terms “comprise,” “include,” or “contain” may be used interchangeably and have the same meaning and are to be construed as inclusive and open-ended. The terms “comprise,” “include,” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

The flowcharts and block diagrams in the figures illustrate examples of the architecture, functionality, and operation of possible implementations of systems, methods, and devices according to various embodiments. It should be noted that, in some alternative implementations, the functions noted in blocks may occur out of the order noted in the figures. For example, two blocks shown in succession may, in fact, be executed substantially concurrently, or the blocks may sometimes be executed in the reverse order, depending upon the functionality involved. Likewise, additional steps may be included in such methods, and certain steps may be omitted or combined, in methods consistent with various embodiments.

It is understood that the described embodiments are not mutually exclusive, and elements, components, materials, or steps described in connection with one example embodiment may be combined with, or eliminated from, other embodiments in suitable ways to accomplish desired design objectives.

Reference herein to “some embodiments” or “some exemplary embodiments” means that a particular feature, structure, or characteristic described in connection with the embodiment can be included in at least one embodiment. The appearance of the phrases “one embodiment” “some embodiments” or “another embodiment” in various places in the present disclosure do not all necessarily refer to the same embodiment, nor are separate or alternative embodiments necessarily mutually exclusive of other embodiments.

Additionally, the articles “a” and “an” as used in the present disclosure and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

Although the elements in the following method claims, if any, are recited in a particular sequence, unless the claim recitations otherwise imply a particular sequence for implementing some or all of those elements, those elements are not necessarily intended to be limited to being implemented in that particular sequence.

It is appreciated that certain features of the present disclosure, which are, for clarity, described in the context of separate embodiments, may also be provided in combination in a single embodiment. Conversely, various features of the specification, which are, for brevity, described in the context of a single embodiment, may also be provided separately or in any suitable subcombination or as suitable in any other described embodiment of the specification. Certain features described in the context of various embodiments are not essential features of those embodiments, unless noted as such.

It will be further understood that various modifications, alternatives, and variations in the details, materials, and arrangements of the parts which have been described and illustrated in order to explain the nature of described embodiments may be made by those skilled in the art without departing from the scope. Accordingly, the following claims embrace all such alternatives, modifications, and variations that fall within the terms of the claims.

Clause 1: A user equipment (UE) for beam management in a communication, the UE comprising:
a memory storing an instruction; and
a processor configured to execute the instruction stored in the memory to: transmit, to a base station, one or more requests for a configuration of one or more resources to be used by the UE to transmit one or more requests to trigger a beam sweeping;
receive, from the base station, the configuration of the one or more resources to be used by the UE to transmit the one or more requests to trigger the beam sweeping;
transmit, to the base station, the one or more requests to trigger the beam sweeping on the one or more resources configured for the UE;
receive, from the base station, a confirmation for the beam sweeping; and
perform the beam sweeping based on the confirmation.

Clause 2: The UE of claim 1, wherein the processor is configured to execute the instruction stored in the memory to:
transmit, to the base station and through a random access procedure, the one or more requests for the configuration of the one or more resources to be used by the UE.

Clause 3: The UE of claim 2, wherein the processor is configured to execute the instruction stored in the memory to:
receive, from the base station and at least through a message 4 (Msg4) of the random access procedure, the configuration of the one or more resources to be used by the UE.

Clause 4: The UE of claim 1, wherein the processor is configured to execute the instruction stored in the memory to:
receive, from the base station, the configuration of the one or more resources to be used by the UE via at least one of: a radio resource control (RRC) signal, medium access control (MAC) control element (CE), or downlink control information (DCI).

Clause 5: The UE of claim 1, wherein the one or more requests to trigger the beam sweeping comprise at least one of: one or more desired occasions to perform the beam sweeping, or one or more configurations for performing the beam sweeping.

Clause 6: The UE of claim 1, wherein the confirmation for the beam sweeping received from the base station comprises at least one of: (1) whether to use channel state information reference signal (CSI-RS) or synchronization signal and physical broadcast channel (SSB) to perform the beam sweeping, (2) one or more sets of beam directions for the beam sweeping, or (3) one or more widths of one or more beams for the beam sweeping.

Clause 7: The UE of claim 1, wherein the processor is configured to execute the instruction stored in the memory to:
perform the beam sweeping at least using a sounding reference signal (SRS).

Clause 8: A user equipment (UE) for beam management in a communication, the UE comprising:
a memory storing an instruction; and
a processor configured to execute the instruction stored in the memory to:
transmit, to a base station and through a random access procedure, one or more requests to trigger a beam sweeping, the one or more requests to trigger the beam sweeping comprising at least one of: one or more desired occasions to perform the beam sweeping, or one or more configurations for performing the beam sweeping;
receive, from the base station, a confirmation for the beam sweeping; and
perform the beam sweeping based on the confirmation.

Clause 9: A base station for beam management in a communication, the base station comprising:
a memory storing an instruction; and
a processor configured to execute the instruction stored in the memory to:
receive, from a user equipment (UE), one or more requests for a configuration of one or more resources to be used by the UE to transmit one or more requests to trigger a beam sweeping;
transmit, to the UE, the configuration of the one or more resources to be used by the UE to transmit the one or more requests to trigger the beam sweeping;
receive, from the UE, the one or more requests to trigger the beam sweeping;
transmit, to the UE, a confirmation for the beam sweeping; and
perform the beam sweeping based on the confirmation.

Clause 10: The base station of claim 9, wherein the processor is configured to execute the instruction stored in the memory to:
receive, from the UE and at least through a random access procedure, the one or more requests for the configuration of the one or more resources to be used by the UE.

Clause 11: The base station of claim 10, wherein the processor is configured to execute the instruction stored in the memory to:
transmit, to the UE and at least through a message 4 (Msg4) of the random access procedure, the configuration of the one or more resources to be used by the UE.

Clause 12: The base station of claim 9, wherein the processor is configured to execute the instruction stored in the memory to:
transmit, to the UE, the configuration of the one or more resources to be used by the UE via at least one of: a radio resource control (RRC) signal, medium access control (MAC) control element (CE), or downlink control information (DCI).

Clause 13: The base station of claim 9, wherein the processor is configured to execute the instruction stored in the memory to:
perform the configuration of the one or more resources to be used by the UE periodically, semi-periodically, or aperiodically.

Clause 14: The base station of claim 9, wherein the processor is configured to execute the instruction stored in the memory to:
receive, from the UE, the one or more requests to trigger the beam sweeping on the configured one or more resources.

Clause 15: The base station of claim 9, wherein the one or more requests to trigger the beam sweeping received from the UE comprises at least one of: one or more desired occasions to perform the beam sweeping, or one or more configurations for performing the beam sweeping.

Clause 16: The base station of claim 9, wherein the confirmation for the beam sweeping transmitted to the UE comprises at least one of: (1) whether to use channel state information reference signal (CSI-RS) or synchronization signal and physical broadcast channel (SSB) to perform the beam sweeping, (2) one or more sets of beam directions for the beam sweeping, or (3) one or more widths of one or more beams for the beam sweeping.

Clause 17: A base station for beam management in a communication, the base station comprising:
a memory storing an instruction; and
a processor configured to execute the instruction stored in the memory to: receive, from a user equipment (UE) and through a random access procedure, one or more requests to trigger a beam sweeping, the one or more requests to trigger the beam sweeping comprising at least one of: one or more desired occasions to perform the beam sweeping, or one or more configurations for performing the beam sweeping;
transmit, to the UE, a confirmation for the beam sweeping; and
perform the beam sweeping based on the confirmation.

Clause 18: A base station for beam management in a communication, the base station comprising:
a memory storing an instruction; and
a processor configured to execute the instruction stored in the memory to:
transmit, to a user equipment (UE), one or more requests for one or more channel state information (CSI) reports, the one or more requests comprising a configuration for one or more CSI measurements to be performed by the UE;
receive, from the UE, the one or more CSI reports;
update one or more learning models included in the base station based on the received one or more CSI reports, the one or more learning models comprising at least one of: one or more weights, or one or more parameters;
determine one or more beam directions for at least one of the base station or the UE, based on the updated one or more learning models; and
transmit, to the UE, the updated one or more learning models or at least one of: updated one or more weights, or updated one or more parameters.

Clause 19: The base station of claim 18, wherein the one or more learning models comprise at least one of:
a learning model for the base station and a learning model for the UE; or
a learning model for both the base station and the UE.

Clause 20: The base station of claim 18, wherein the one or more learning models comprise a learning model for the base station and a learning model for the UE, and the processor is configured to execute the instruction stored in the memory to:
update the learning model for the base station and the learning model for the UE based on the received one or more CSI reports.

Clause 21: The base station of claim 20, wherein the processor is configured to execute the instruction stored in the memory to: determine the one or more beam directions for the base station.

Clause 22: The base station of claim 20, wherein the processor is configured to execute the instruction stored in the memory to: transmit, to the UE, an updated learning model for the UE, or at least one of: updated one or more weights, or updated one or more parameters, of the learning model for the UE.

Clause 23: The base station of claim 18, wherein the one or more learning models comprise a learning model for both the base station and the UE, and the processor is configured to execute the instruction stored in the memory to:
update the learning model for both the base station and the UE, based on the received one or more CSI reports.

Clause 24: The base station of claim 23, wherein the processor is configured to execute the instruction stored in the memory to: determine the one or more beam directions for both the base station and the UE.

Clause 25: The base station of claim 24, wherein the processor is configured to execute the instruction stored in the memory to: transmit, to the UE, at least one of: one or more beam directions for the UE at a current time, or one or more beam directions for the UE at a future time.

Clause 26: The base station of claim 18, wherein the processor is further configured to execute the instruction stored in the memory to:
configure one or more resources for transmitting the updated one or more learning models or at least one of: the updated one or more weights, or the updated one or more parameters; and
inform the configured one or more resources to the UE.

Clause 27: The base station of claim 18, wherein the processor is further configured to execute the instruction stored in the memory to:
inform, to the UE, one or more supported structures for the one or more learning models via a master information block (MIB) or a system information block (SIB).

Clause 28: The base station of claim 18, wherein the processor is further configured to execute the instruction stored in the memory to:
receive, from the UE, one or more supported structures for the one or more learning models, the one or more supported structures being included in UE capability information that is transmitted via an RRC signal.

Clause 29: The base station of claim 18, wherein one or more neural networks are adopted by the base station, and a structure of the one or more learning models is specified based on at least one of:
a number of neural network layers,
a number of neural nodes in each neural network layer,
one or more connection structures between the neural network layers,
one or more types of the neural network layers,
one or more types of connections of the neural nodes,
one or more types of computing operation in each neural node,
a number of weights of the one or more neural networks,
a number of parameters of the one or more neural networks,
one or more types of weights of the one or more neural networks,
one or more types of parameters of the one or more neural networks, or
one or more loss functions of the one or more neural networks.

Clause 30: The base station of claim 18, wherein one or more deep reinforcement learning (DRL) methods are adopted by the base station, and a structure of the one or more learning models is specified based on at least one of:
a state space of the DRL,
an action space of the DRL,
one or more reward functions of the DRL,
a size of replay memory and a content in replay memory, or
a minimum batch size for sampling in a replay memory.

Clause 31: The base station of claim 18, wherein the processor is further configured to execute the instruction stored in the memory to:
update the one or more learning models included in the base station, in response to a determination that one or more measurements in the one or more CSI reports received from the UE are lower than a predetermined threshold.

Clause 32: A user equipment (UE) for beam management in a communication, the UE comprising:
a memory storing an instruction; and
a processor configured to execute the instruction stored in the memory to:
receive, from a base station, one or more requests for one or more channel state information (CSI) reports, the one or more requests comprising a configuration for one or more CSI measurements to be performed by the UE;
transmit, to the base station, the one or more CSI reports;
receive, from the base station, an updated learning model for the UE, or at least one of: updated one or more weights, or updated one or more parameters, of the learning model for the UE, the learning model for the UE being included in the base station and updated by the base station based on the one or more CSI reports; and
determine one or more beam directions for the UE based on the updated learning model for the UE, or the at least one of: the updated one or more weights, or the updated one or more parameters, of the learning model for the UE.

Clause 33: The UE of claim 32, wherein the one or more beam directions for the UE comprises at least one of: the one or more beam directions for the UE at a current time, or the one or more beam directions for the UE at a future time.

Clause 34: The UE of claim 32, wherein the processor is further configured to execute the instruction stored in the memory to:
receive, from the base station, one or more resources configured for transmission of the updated learning model for the UE, or the at least one of: the updated one or more weights, or the updated one or more parameters, of the learning model for the UE.

Clause 35: The UE of claim 32, wherein the processor is further configured to execute the instruction stored in the memory to:
receive, from the base station, one or more supported structures for a learning model for the base station via a master information block (MIB) or a system information block (SIB).

Clause 36: The UE of claim 32, wherein the processor is further configured to execute the instruction stored in the memory to:
transmit, to the base station and via at least one of a radio resource control (RRC) signal, medium access control (MAC) control element (CE), or downlink control information (DCI), one or more supported structures for the learning model for the UE.

Clause 37: A user equipment (UE) for beam management in a communication, the UE comprising:
a memory storing an instruction; and
a processor configured to execute the instruction stored in the memory to:
receive, from a base station, one or more requests for one or more channel state information (CSI) reports, the one or more requests comprising a configuration for one or more CSI measurements to be performed by the UE;
transmit, to the base station, the one or more CSI reports;
receive, from the base station, one or more beam directions for the UE determined by a learning model included in the base station, the learning model being a learning model for both the UE and the base station; and
determine a beam to be used by the UE based on the received one or more beam directions.

Clause 38: The UE of claim 37, wherein the one or more beam directions for the UE comprise at least one of: the one or more beam directions for the UE at a current time, or the one or more beam directions for the UE at a future time.

Clause 39: A user equipment (UE) for beam management in a communication, the UE comprising:
a memory storing an instruction; and
a processor configured to execute the instruction stored in the memory to:
identify an optimum beam pair based on one or more signals received from a base station;
update one or more learning models included in the UE based on the identified optimum beam pair, the one or more learning models comprising at least one of: one or more weights, or one or more parameters;
determine one or more beam directions for at least one of the UE or the base station, based on the updated one or more learning models; and
transmit, to the base station, the updated one or more learning models, or at least one of: updated one or more weights, or updated one or more parameters.

Clause 40: The UE of claim 39, wherein the processor is further configured to execute the instruction stored in the memory to:
transmit, to the base station, one or more requests for a configuration of one or more resources to be used by the UE to transmit one or more requests to trigger a beam sweeping;
receive, from the base station, the configuration of the one or more resources; and
transmit, to the base station, the one or more requests to trigger the beam sweeping based on the received configuration of the one or more resources.

Clause 41: The UE of claim 39, wherein the processor is further configured to execute the instruction stored in the memory to:
identify the optimum beam pair based on one or more measurements on at least one of channel state information reference signal (CSI-RS) or synchronization signal and physical broadcast channel (SSB) received from the base station; or
identify the optimum beam pair via a beam sweeping triggered by the base station.

Clause 42: The UE of claim 39, wherein the one or more learning models comprise at least one of:
a learning model for the UE and a learning model for the base station; or
a learning model for both the UE and the base station.

Clause 43: The UE of claim 39, wherein the processor is further configured to execute the instruction stored in the memory to:
transmit, to the base station, one or more requests for a configuration of one or more resources to be used by the UE for transmission of the updated one or more learning models, or at least one of: the updated one or more weights, or the updated one or more parameters;
receive, from the base station, the configuration of the one or more resources to be used by the UE; and
transmit, to the base station, the updated one or more learning models, or at least one of: the updated one or more weights, or the updated one or more parameters, based on the configuration of the one or more resources.

Clause 44: The UE of claim 39, wherein the one or more learning models comprise a learning model for the base station and a learning model for the UE, and the processor is further configured to execute the instruction stored in the memory to:
update the learning model for the UE and the learning model for the base station, based on the identified optimum beam pair.

Clause 45: The UE of claim 44, wherein the processor is configured to execute the instruction stored in the memory to determine the one or more beam directions for the UE.

Clause 46: The UE of claim 44, wherein the processor is configured to execute the instruction stored in the memory to: transmit, to the base station, an updated learning model for the base station, or at least one of: updated one or more weights, or updated one or more parameters, of the learning model for the base station.

Clause 47: The UE of claim 39 wherein the one or more learning models comprise a learning model for both the UE and the base station, and the processor is further configured to execute the instruction stored in the memory to:
update the learning model for both the UE and the base station, based on the identified optimum beam pair.

Clause 48: The UE of claim 47, wherein the processor is configured to execute the instruction stored in the memory to: determine the one or more beam directions for both the UE and the base station.

Clause 49: The UE of claim 48, wherein the processor is configured to execute the instruction stored in the memory to: transmit, to the base station, at least one of: the one or more beam directions for the base station at a current time, or one or more beam directions for the base station at a future time.

Clause 50: The UE of claim 39, wherein one or more neural networks are adopted by the UE, and a structure of the one or more learning models is specified based on at least one of:
a number of neural network layers,
a number of neural nodes in each neural network layer,
one or more connection structures between the neural network layers,
one or more types of the neural network layers,
one or more types of connections of the neural nodes,
one or more types of computing operation in each neural node,
a number of weights of the one or more neural networks,
a number of parameters of the one or more neural networks,
one or more types of weights of the one or more neural networks,
one or more types of parameters of the one or more neural networks, or
one or more loss functions of the one or more neural networks.

Clause 51: The UE of claim 39, wherein one or more deep reinforcement learning (DRL) methods are adopted by the base station, and a structure of the one or more learning models is specified based on at least one of:
a state space of the DRL,
an action space of the DRL,
one or more reward functions of the DRL,
a size of replay memory and a content in replay memory, or
a minimum batch size for sampling in a replay memory.

Clause 52: A base station for beam management in a communication, the base station comprising:
a memory storing an instruction; and
a processor configured to execute the instruction stored in the memory to:
receive, from a user equipment (UE), an updated learning model for the base station, or at least one of: updated one or more weights, or updated one or more parameters, of the learning model for the base station, the learning model for the base station being included in the UE and updated by the UE; and
determine one or more beam directions for the base station based on the received updated learning model for the base station, or at least one of: the updated one or more weights, or the updated one or more parameters, of the learning model for the base station.

Clause 53: The base station of claim 52, wherein the one or more beam directions for the base station comprises at least one of: the one or more beam directions for the base station at a current time, or the one or more beam directions for the base station at a future time.

Clause 54: A base station for beam management in a communication, the base station comprising:
a memory storing an instruction; and
a processor configured to execute the instruction stored in the memory to:
receive, from a user equipment (UE), one or more beam directions for the base station determined by a learning model included in the UE, the learning model being a learning model for both the UE and the base station; and
determine a beam for the base station based on the received one or more beam directions.

Clause 55: The base station of claim 54, wherein the one or more beam directions for the base station comprise at least one of: the one or more beam directions for the base station at a current time, or the one or more beam directions for the base station at a future time.

Clause 56: A method for a user equipment (UE) for beam management in a communication, the method comprising:
transmitting, to a base station, one or more requests for a configuration of one or more resources to be used by the UE to transmit one or more requests to trigger a beam sweeping; receiving, from the base station, the configuration of the one or more resources to be used by the UE to transmit the one or more requests to trigger the beam sweeping;
transmitting, to the base station, the one or more requests to trigger the beam sweeping on the one or more resources configured for the UE;
receiving, from the base station, a confirmation for the beam sweeping; and
performing the beam sweeping based on the confirmation.

Clause 57: A method for a user equipment (UE) for beam management in a communication, the method comprising:
transmitting, to a base station and through a random access procedure, one or more requests to trigger a beam sweeping, the one or more requests to trigger the beam sweeping comprising at least one of: one or more desired occasions to perform the beam sweeping, or one or more configurations for performing the beam sweeping;
receiving, from the base station, a confirmation for the beam sweeping; and
performing the beam sweeping based on the confirmation.

Clause 58: A method for a base station for beam management in a communication, the method comprising:
receiving, from a user equipment (UE), one or more requests for a configuration of one or more resources to be used by the UE to transmit one or more requests to trigger a beam sweeping;
transmitting, to the UE, the configuration of the one or more resources to be used by the UE to transmit the one or more requests to trigger the beam sweeping;
receiving, from the UE, the one or more requests to trigger the beam sweeping;
transmitting, to the UE, a confirmation for the beam sweeping; and
performing the beam sweeping based on the confirmation.

Clause 59: A method for a base station for beam management in a communication, the method comprising:
receiving, from a user equipment (UE) and through a random access procedure, one or more requests to trigger a beam sweeping, the one or more requests to trigger the beam sweeping comprising at least one of: one or more desired occasions to perform the beam sweeping, or one or more configurations for performing the beam sweeping;
transmitting, to the UE, a confirmation for the beam sweeping; and
performing the beam sweeping based on the confirmation.

Clause 60: A method for a base station for beam management in a communication, the method comprising:
transmitting, to a user equipment (UE), one or more requests for one or more channel state information (CSI) reports, the one or more requests comprising a configuration for one or more CSI measurements to be performed by the UE;
receiving, from the UE, the one or more CSI reports;
updating one or more learning models included in the base station based on the received one or more CSI reports, the one or more learning models comprising at least one of: one or more weights, or one or more parameters;
determining one or more beam directions for at least one of the base station or the UE, based on the updated one or more learning models; and
transmitting, to the UE, the updated one or more learning models or at least one of: updated one or more weights, or updated one or more parameters.

Clause 61: A method for a user equipment (UE) for beam management in a communication, the method comprising:
receiving, from a base station, one or more requests for one or more channel state information (CSI) reports, the one or more requests comprising a configuration for one or more CSI measurements to be performed by the UE;
transmitting, to the base station, the one or more CSI reports;
receiving, from the base station, an updated learning model for the UE, or at least one of: updated one or more weights, or updated one or more parameters, of the learning model for the UE, the learning model for the UE being included in the base station and updated by the UE based on the one or more CSI reports; and
determining one or more beam directions for the UE based on the updated learning model for the UE, or the at least one of: the updated one or more weights, or the updated one or more parameters, of the learning model for the UE.

Clause 62: A method for a user equipment (UE) for beam management in a communication, the method comprising:
receiving, from a base station, one or more requests for one or more channel state information (CSI) reports, the one or more requests comprising a configuration for one or more CSI measurements to be performed by the UE;
transmitting, to the base station, the one or more CSI reports;
receiving, from the base station, one or more beam directions for the UE determined by a learning model included in the base station, the learning model being a learning model for both the UE and the base station; and
determining a beam to be used by the UE based on the received one or more beam directions.

Clause 63: A method for a user equipment (UE) for beam management in a communication, the method comprising:
identifying an optimum beam pair based on one or more signals received from a base station; updating one or more learning models included in the UE based on the identified optimum beam pair, the one or more learning models comprising at least one of: one or more weights, or one or more parameters;
determining one or more beam directions for at least one of the UE or the base station, based on the updated one or more learning models; and
transmitting, to the base station, the updated one or more learning models, or at least one of: updated one or more weights, or updated one or more parameters.

Clause 64: A method for a base station for beam management in a communication, the method comprising:
receiving, from a user equipment (UE), an updated learning model for the base station, or at least one of: updated one or more weights, or updated one or more parameters, of the learning model for the base station, the learning model for the base station being included in the UE and updated by the UE; and
determining one or more beam directions for the base station based on the received updated learning model for the base station, or at least one of: the updated one or more weights, or the updated one or more parameters, of the learning model for the base station.

Clause 65: A method for a base station for beam management in a communication, the method comprising:
receiving, from a user equipment (UE), one or more beam directions for the base station determined by a learning model included in the UE, the learning model being a learning model for both the UE and the base station; and
determining a beam for the base station based on the received one or more beam directions.

Clause 66: A non-transitory computer-readable medium storing instructions that are executable by one or more processors of a user equipment (UE) for communication, to perform a method for beam management, the method comprising:
transmitting, to a base station, one or more requests for a configuration of one or more resources to be used by the UE to transmit one or more requests to trigger a beam sweeping; receiving, from the base station, the configuration of the one or more resources to be used by the UE to transmit the one or more requests to trigger the beam sweeping;
transmitting, to the base station, the one or more requests to trigger the beam sweeping on the one or more resources configured for the UE;
receiving, from the base station, a confirmation for the beam sweeping; and
performing the beam sweeping based on the confirmation.

Clause 67: A non-transitory computer-readable medium storing instructions that are executable by one or more processors of a user equipment (UE) for communication, to perform a method for beam management, the method comprising:
transmitting, to a base station and through a random access procedure, one or more requests to trigger a beam sweeping, the one or more requests to trigger the beam sweeping comprising at least one of: one or more desired occasions to perform the beam sweeping, or one or more configurations for performing the beam sweeping;
receiving, from the base station, a confirmation for the beam sweeping; and
performing the beam sweeping based on the confirmation. Clause 68: A non-transitory computer-readable medium storing instructions that are executable by one or more processors of a base station for communication, to perform a method for beam management, the method comprising:
receiving, from a user equipment (UE), one or more requests for a configuration of one or more resources to be used by the UE to transmit one or more requests to trigger a beam sweeping;
transmitting, to the UE, the configuration of the one or more resources to be used by the UE to transmit the one or more requests to trigger the beam sweeping;
receiving, from the UE, the one or more requests to trigger the beam sweeping;
transmitting, to the UE, a confirmation for the beam sweeping; and
performing the beam sweeping based on the confirmation.

Clause 69: A non-transitory computer-readable medium storing instructions that are executable by one or more processors of a base station for communication, to perform a method for beam management, the method comprising:
receiving, from a user equipment (UE) and through a random access procedure, one or more requests to trigger a beam sweeping, the one or more requests to trigger the beam sweeping comprising at least one of: one or more desired occasions to perform the beam sweeping, or one or more configurations for performing the beam sweeping;
transmitting, to the UE, a confirmation for the beam sweeping; and
performing the beam sweeping based on the confirmation.

Clause 70: A non-transitory computer-readable medium storing instructions that are executable by one or more processors of a base station for communication, to perform a method for beam management, the method comprising:
transmitting, to a user equipment (UE), one or more requests for one or more channel state information (CSI) reports, the one or more requests comprising a configuration for one or more CSI measurements to be performed by the UE;
receiving, from the UE, the one or more CSI reports;
updating one or more learning models included in the base station based on the received one or more CSI reports, the one or more learning models comprising at least one of: one or more weights, or one or more parameters;
determining one or more beam directions for at least one of the base station or the UE, based on the updated one or more learning models; and
transmitting, to the UE, the updated one or more learning models or at least one of: updated one or more weights, or updated one or more parameters.

Clause 71: A non-transitory computer-readable medium storing instructions that are executable by one or more processors of a user equipment (UE) for communication, to perform a method for beam management, the method comprising:
receiving, from a base station, one or more requests for one or more channel state information (CSI) reports, the one or more requests comprising a configuration for one or more CSI measurements to be performed by the UE;
transmitting, to the base station, the one or more CSI reports;
receiving, from the base station, an updated learning model for the UE, or at least one of:
updated one or more weights, or updated one or more parameters, of the learning model for the UE, the learning model for the UE being included in the base station and updated by the UE based on the one or more CSI reports; and
determining one or more beam directions for the UE based on the updated learning model for the UE, or the at least one of: the updated one or more weights, or the updated one or more parameters, of the learning model for the UE.

Clause 72: A non-transitory computer-readable medium storing instructions that are executable by one or more processors of a user equipment (UE) for communication, to perform a method for beam management, the method comprising:
receiving, from a base station, one or more requests for one or more channel state information (CSI) reports, the one or more requests comprising a configuration for one or more CSI measurements to be performed by the UE;
transmitting, to the base station, the one or more CSI reports;
receiving, from the base station, one or more beam directions for the UE determined by a learning model included in the base station, the learning model being a learning model for both the UE and the base station; and
determining a beam to be used by the UE based on the received one or more beam directions.

Clause 73: A non-transitory computer-readable medium storing instructions that are executable by one or more processors of a user equipment (UE) for communication, to perform a method for beam management, the method comprising:
identifying an optimum beam pair based on one or more signals received from a base station;
updating one or more learning models included in the UE based on the identified optimum beam pair, the one or more learning models comprising at least one of: one or more weights, or one or more parameters;
determining one or more beam directions for at least one of the UE or the base station, based on the updated one or more learning models; and
transmitting, to the base station, the updated one or more learning models, or at least one of: updated one or more weights, or updated one or more parameters.

Clause 74: A non-transitory computer-readable medium storing instructions that are executable by one or more processors of a base station for communication, to perform a method for beam management, the method comprising:
receiving, from a user equipment (UE), an updated learning model for the base station, or at least one of: updated one or more weights, or updated one or more parameters, of the learning model for the base station, the learning model for the base station being included in the UE and updated by the UE; and
determining one or more beam directions for the base station based on the received updated learning model for the base station, or at least one of: the updated one or more weights, or the updated one or more parameters, of the learning model for the base station.

Clause 75: A non-transitory computer-readable medium storing instructions that are executable by one or more processors of a base station for communication, to perform a method for beam management, the method comprising:
receiving, from a user equipment (UE), one or more beam directions for the base station determined by a learning model included in the UE, the learning model being a learning model for both the UE and the base station; and
determining a beam for the base station based on the received one or more beam directions.

1. A user equipment (UE) for beam management in a communication, the UE comprising:
a memory storing an instruction; and
a processor configured to execute the instruction stored in the memory to:
transmit, to a base station, one or more requests for a configuration of one or more resources to be used by the UE to transmit one or more requests to trigger a beam sweeping;
receive, from the base station, the configuration of the one or more resources to be used by the UE to transmit the one or more requests to trigger the beam sweeping;
transmit, to the base station, the one or more requests to trigger the beam sweeping on the one or more resources configured for the UE;
receive, from the base station, a confirmation for the beam sweeping; and
perform the beam sweeping based on the confirmation.

2. The UE of claim 1, wherein the processor is configured to execute the instruction stored in the memory to:
transmit, to the base station and through a random access procedure, the one or more requests for the configuration of the one or more resources to be used by the UE.

3. The UE of claim 2, wherein the processor is configured to execute the instruction stored in the memory to:
receive, from the base station and at least through a message 4 (Msg4) of the random access procedure, the configuration of the one or more resources to be used by the UE.

4. The UE of claim 1, wherein the processor is configured to execute the instruction stored in the memory to:
receive, from the base station, the configuration of the one or more resources to be used by the UE via at least one of: a radio resource control (RRC) signal, medium access control (MAC) control element (CE), or downlink control information (DCI).

5. The UE of claim 1, wherein the one or more requests to trigger the beam sweeping comprise at least one of: one or more desired occasions to perform the beam sweeping, or one or more configurations for performing the beam sweeping.

6. The UE of claim 1, wherein the confirmation for the beam sweeping received from the base station comprises at least one of: (1) whether to use channel state information reference signal (CSI-RS) or synchronization signal and physical broadcast channel (SSB) to perform the beam sweeping, (2) one or more sets of beam directions for the beam sweeping, or (3) one or more widths of one or more beams for the beam sweeping.

7. The UE of claim 1, wherein the processor is configured to execute the instruction stored in the memory to:
perform the beam sweeping at least using a sounding reference signal (SRS).

8. A user equipment (UE) for beam management in a communication, the UE comprising:
a memory storing an instruction; and
a processor configured to execute the instruction stored in the memory to:
transmit, to a base station and through a random access procedure, one or more requests to trigger a beam sweeping, the one or more requests to trigger the beam sweeping comprising at least one of: one or more desired occasions to perform the beam sweeping, or one or more configurations for performing the beam sweeping;
receive, from the base station, a confirmation for the beam sweeping; and
perform the beam sweeping based on the confirmation.

9. A base station for beam management in a communication, the base station comprising:
a memory storing an instruction; and
a processor configured to execute the instruction stored in the memory to:
receive, from a user equipment (UE), one or more requests for a configuration of one or more resources to be used by the UE to transmit one or more requests to trigger a beam sweeping;
transmit, to the UE, the configuration of the one or more resources to be used by the UE to transmit the one or more requests to trigger the beam sweeping;
receive, from the UE, the one or more requests to trigger the beam sweeping;
transmit, to the UE, a confirmation for the beam sweeping; and
perform the beam sweeping based on the confirmation.

10. The base station of claim 9, wherein the processor is configured to execute the instruction stored in the memory to:
receive, from the UE and at least through a random access procedure, the one or more requests for the configuration of the one or more resources to be used by the UE.

11. The base station of claim 10, wherein the processor is configured to execute the instruction stored in the memory to:
transmit, to the UE and at least through a message 4 (Msg4) of the random access procedure, the configuration of the one or more resources to be used by the UE.

12. The base station of claim 9, wherein the processor is configured to execute the instruction stored in the memory to:
transmit, to the UE, the configuration of the one or more resources to be used by the UE via at least one of: a radio resource control (RRC) signal, medium access control (MAC) control element (CE), or downlink control information (DCI).

13. The base station of claim 9, wherein the processor is configured to execute the instruction stored in the memory to:
perform the configuration of the one or more resources to be used by the UE periodically, semi-periodically, or aperiodically.

14. The base station of claim 9, wherein the processor is configured to execute the instruction stored in the memory to:
receive, from the UE, the one or more requests to trigger the beam sweeping on the configured one or more resources.

15. The base station of claim 9, wherein the one or more requests to trigger the beam sweeping received from the UE comprises at least one of: one or more desired occasions to perform the beam sweeping, or one or more configurations for performing the beam sweeping.

16. The base station of claim 9, wherein the confirmation for the beam sweeping transmitted to the UE comprises at least one of:
(1) whether to use channel state information reference signal (CSI-RS) or synchronization signal and physical broadcast channel (SSB) to perform the beam sweeping,
(2) one or more sets of beam directions for the beam sweeping, or
(3) one or more widths of one or more beams for the beam sweeping.

17. A base station for beam management in a communication, the base station comprising:
a memory storing an instruction; and
a processor configured to execute the instruction stored in the memory to:
receive, from a user equipment (UE) and through a random access procedure, one or more requests to trigger a beam sweeping, the one or more requests to trigger the beam sweeping comprising at least one of: one or more desired occasions to perform the beam sweeping, or one or more configurations for performing the beam sweeping;
transmit, to the UE, a confirmation for the beam sweeping; and
perform the beam sweeping based on the confirmation.

18. A base station for beam management in a communication, the base station comprising:
a memory storing an instruction; and
a processor configured to execute the instruction stored in the memory to:
transmit, to a user equipment (UE), one or more requests for one or more channel state information (CSI) reports, the one or more requests comprising a configuration for one or more CSI measurements to be performed by the UE;
receive, from the UE, the one or more CSI reports;
update one or more learning models included in the base station based on the received one or more CSI reports, the one or more learning models comprising at least one of: one or more weights, or one or more parameters;
determine one or more beam directions for at least one of the base station or the UE, based on the updated one or more learning models; and
transmit, to the UE, the updated one or more learning models or at least one of: updated one or more weights, or updated one or more parameters.

19. The base station of claim 18, wherein the one or more learning models comprise at least one of:
a learning model for the base station and a learning model for the UE; or
a learning model for both the base station and the UE.

20. The base station of claim 18, wherein the one or more learning models comprise a learning model for the base station and a learning model for the UE, and the processor is configured to execute the instruction stored in the memory to:
update the learning model for the base station and the learning model for the UE based on the received one or more CSI reports.

21-75. (canceled)
